(19) United States
(12) Patent Application Publication
(10) Pub. No.: US 2025/0188288 A1
(43) Pub. Date: Jun. 12, 2025

(54) ANTI-FOULING POLYMERIC AGENTS

(71) Applicants: Mark Ieuan EDWARDS, Surrey (GB); Vivienne Rosalind EDWARDS, Surrey (GB)

(72) Inventors: Mark Ieuan EDWARDS, Surrey (GB); Vivienne Rosalind EDWARDS, Surrey (GB)

(21) Appl. No.: 18/844,181

(22) PCT Filed: Mar. 10, 2023
(86) PCT No.: PCT/GB2023/050575

§ 371 Date: Sep. 5, 2024

(30) Foreign Application Priority Data
Mar. 11, 2022 (GB) 2203401.1

(51) Int. Cl. C09D 5/16; C09D 5/08

(52) U.S. Cl. CPC C09D 5/1637; C09D 5/084

(57) ABSTRACT

The invention relates to the use of polymers and polymeric agents in preventing hard and soft fouling and corrosion, particularly although not exclusively, on the surface of marine equipment. Additionally, the invention relates to the novel combination of polymers with a ceramic coating, and its use as an anti-fouling or anti-corrosive agent.

The present invention relates to the use of polymers and polymeric agents in preventing hard and soft fouling and corrosion, particularly although not exclusively, on the surface of marine equipment. Additionally, the invention relates to the novel combination of polymers with a ceramic coating, and its use as an anti-fouling or anti-corrosive agent.

The majority of existing anti-fouling systems use toxic biocides, such as copper (I) oxide. These agents work by killing marine life on boat surfaces to suppress and prevent fouling. However, a problem with using these compounds is that they require high biocide loading (up to 50%) to be effective [1]. Additionally, a key issue with the majority of these anti-fouling technologies, is that they are toxic to humans using them and to the marine environment. As such, new regulations [2], limit their continued use due to their negative environmental impact and toxicity to humans.

Non-biocide-based formulations have recently entered the market. For example, Hempel has introduced Hempel Silic One, a copper and biocide free fouling release system, based on silicon and hydrogel, giving the coating hydrophilic or water like properties. This system claims to make it more difficult for fouling organisms to attach to the hull, make the removal of fouling organisms easier once the vessel is under way, and reduce friction through the water. Additionally, Nippon Paint Marine has introduced a biocide free formulation, Aquaterras, with self-polishing copolymer anti-fouling technology [3]. Furthermore, Sea Coat SCT has introduced Silicone-polysiloxane-Silane-Siloxane based surface coatings [4].

These existing biocide free formulations work by either providing a low energy surface that is hard for fouling organisms to attach to, or as a self-shedding surface that is continually removed, thus shedding any fouling organisms with it. However, these non-biocide-based coatings require expert application, and provide limited additional secondary product benefits, such as corrosion and abrasion resistance, surface smoothness and durability [5].

There is, therefore, a need to provide an improved anti-fouling and anti-corrosive agent, for use on surfaces which are susceptible to fouling and corrosion, such as the surfaces of marine equipment.

The inventor has identified alternative anti-fouling agents, comprising polymers derived from 2-methacryloyloxyethyl phosphorylcholine (MPC) and polymerised with different functional monomers, and cetyl dimethicone copolyol (CDC), that differ significantly from the existing non-biocide formulations available, and use different polymeric characteristics and chemistry.

Therefore, according to a first aspect of the invention, there is provided use of a (i) polymer comprising phosphorylcholine and/or (ii) dimethicone copolyol, as an anti-fouling and/or anti-corrosive agent.

According to a second aspect of the invention, there is provided a method of protecting a surface from fouling and/or corrosion, comprising contacting the surface with a (i) polymer comprising phosphorylcholine and/or (ii) dimethicone copolyol.

Advantageously, the polymers used according to the invention modify the surface chemistry, preventing hard and soft fouling and corrosion on surfaces, such as marine equipment. In addition, the inventor has surprisingly discovered that the anti-fouling benefit and durability of the polymer coating is extended when these materials are combined with a ceramic coating, which also provides additional secondary product benefits, including abrasion resistance, surface smoothness, gloss, UV resistance and durability.

It will be well understood by the skilled person that dimethicone copolyol is a polymer. The polymer comprising phosphorylcholine may be referred to as a biocompatible polymer, and the dimethicone copolyol may be referred to as an polymer with alkyl groups that hinder attachment by virtue of the pendent/projecting alkyl groups.

In one embodiment, the polymer comprising phosphorylcholine is used as an anti-fouling and/or anti-corrosive agent. In another embodiment, the dimethicone copolyol is used as an anti-fouling and/or anti-corrosive agent.

Alternatively, in another embodiment, the polymer comprising phosphorylcholine and dimethicone copolyol are used in combination as an anti-fouling and/or anti-corrosive agent. In this embodiment, the polymer comprising phosphorylcholine and dimethicone copolyol are in a ratio from about 1:10 to about 10:1 by weight. In a preferred embodiment, the polymer comprising phosphorylcholine and dimethicone copolyol are in a ratio from about 29:18 to about 18:29 by weight.

2-methacryloyloxy ethyl phosphorylcholine polymers have been defined as amphiphilic block copolymers comprising, at least in part, 2-methacryloyloxy ethyl phosphorylcholine monomers. The ingredients are constructed as vinyl-type polymers and share in common these phosphorylcholine substituted acrylate monomers.

2-methacryloyloxy ethyl phosphorylcholine (MPC) enables polymerisation so that long chain polymers with pendent phosphorylcholine groups can be created [6].

Accordingly, in a preferred embodiment, the polymer comprises 2-methacryloyloxyethyl phosphorylcholine (MPC).

In one embodiment, 2-methacryloyloxyethyl phosphorylcholine (MPC) has the formula (I):

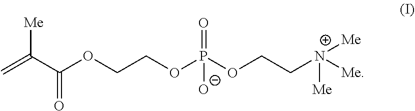 [SMILES: C=C(C)C(=O)OCCOP(=O)([O-])OCC[N+](C)(C)C]

2-methacryloyloxyethyl phosphorylcholine is available from NOF Corporation, Japan, and marketed under the Trade Name Lipidure®-HM. The polymer comprising 2-methacryloyloxyethyl phosphorylcholine (MPC), i.e. Formula (I), may also be referred to as polyphosphorylcholine glycol acrylate. The chemical name of this polymer is 3,5,8-Trioxa-4-phsophaundec-10-en-1-aMiniuM,4-hydroxy-N,N,N,10-tetraMethyl-9-oxo-,inner salt, 4-oxide, homopolymer.

2-methacryloyloxyethyl phosphorylcholine (MPC) polymers may be prepared by free-radical polymerisation [5], one embodiment of which is illustrated in FIG. 19. The MPC monomer (concentration 10-30%) and solvent solution may be prepared, followed by nitrogen bubbling for approximately 30 minutes (20-50 ml/minute). The solution may then be heated at 50-70° C. with slight nitrogen bubbling. An initiator, (e.g. AIBN) may be added and polymerisation occurs at 50-70° C., for 6-8 hours, with slight nitrogen bubbling. The solution may then be cooled, followed by reprecipitation, filtration and drying.

2-methacryloyloxyethyl phosphorylcholine (MPC) has the same zwitterionic structure, i.e. having separate positively and negatively charged groups, as the phosphatidylcholine polar bases that form the cell membrane [7]. As such, water associates with the zwitterionic groups, hiding the surface in a similar manner to the outer coating of a blood cell.

Accordingly, in one embodiment, the polymer comprising phosphorylcholine (and preferably 2-methacryloyloxyethyl phosphorylcholine), may have a zwitterionic structure. The term zwitterionic, as used herein, means having both positive and negative charges.

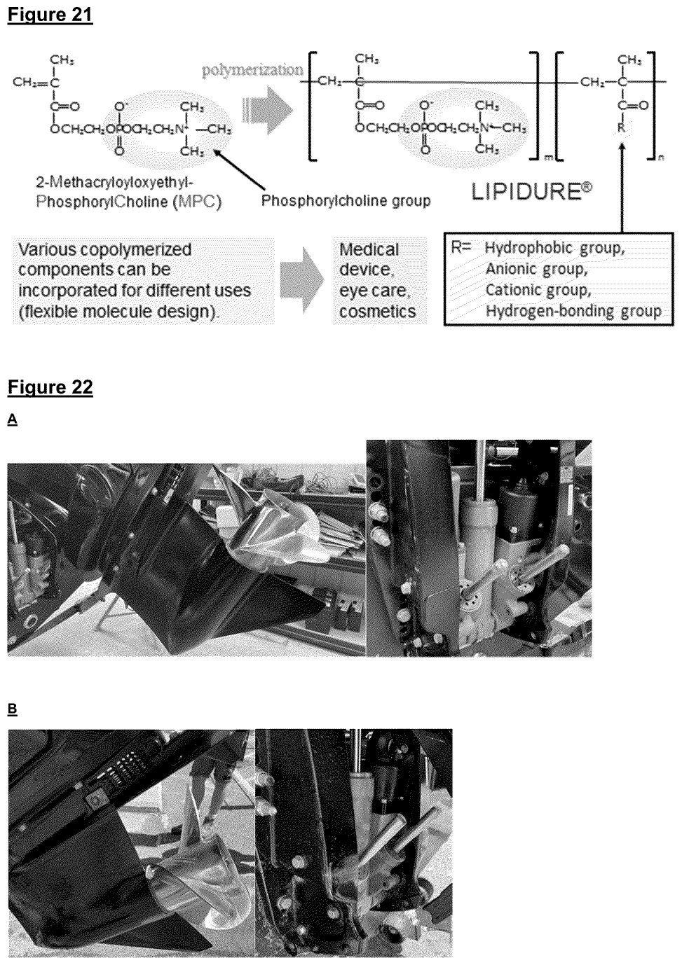

The polymer comprising phosphorylcholine (preferably 2-methacryloyloxyethyl phosphorylcholine) may be further functionalised with groups, such as anionic or cationic groups (i.e. by the addition of a co-monomer), as illustrated in FIGS. 20 and 21. Accordingly, in one embodiment, the polymer comprising 2-methacryloyloxyethyl phosphorylcholine has the formula (II):

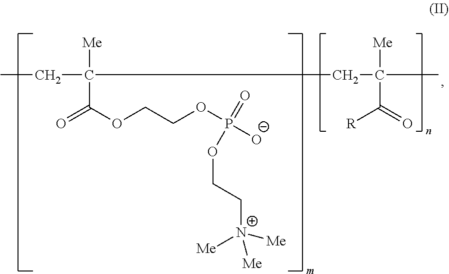

wherein m is an integer of 1 to 1000, and
n is an integer of 1 to 1000, and
R is selected from a group consisting of: a hydrophobic group; an anionic group; a cationic group; and a hydrogen-bonding group.

In a preferred embodiment, m is an integer of 1 to 500, 1 to 100, 1 to 50, or 1 to 10. In another preferred embodiment, n is an integer of 1 to 500, 1 to 100, 1 to 50, or 1 to 10.

Suitable hydrophobic groups may include alkanes, such as methane, ethane, propane, n-butyl, or octadecyl. In a preferred embodiment, the hydrophobic group is n-butyl methacrylate or octadecyl 2 methyl-2-propanoate.

Suitable anionic groups may include carboxylic acid, methyl esters, chloride, bromide, iodide, sulfate, nitrate, hydroxide, or hydride.

Suitable cationic groups may include ammonium, sodium, potassium, magnesium, iron, calcium or aluminium. In a preferred embodiment, the cationic group is trimethyl ammonium chloride.

Suitable hydrogen-bonding groups may include ammonia, chloroform, hydrofluoric acid, or polymers containing, hydroxyl, carboxylic, carbonyl or amide groups.

In one embodiment, the polymer comprising phosphorylcholine (and preferably 2-methacryloyloxyethyl phosphorylcholine) further comprises cationic groups. Accordingly, in this embodiment, the MPC polymer is a cationic MPC polymer (polyquaternium-64) with a commercial trade name Lipidure®-C. In this embodiment, the cationic group is trimethylammonium chloride ((2-hydroxy-3-methacryloxypropyl) trimethylammonium chloride). The chemical name of this polymer is 3,5,8-trioxa-4-phosphaundec-10-en-1-aminium, 4-hydroxy-n,n,n,10-tetramethyl-9-oxo-, inner salt, 4-oxide, polymer with 2-hydroxy-n,n,n-trimethyl-3-((2-methyl-1-oxo-2-propenyl)oxy)-1-propanaminium chloride.

Accordingly, in one embodiment, the polymer comprising 2-methacryloyloxyethyl phosphorylcholine has the formula (III):

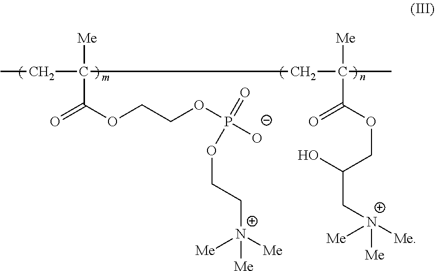

In another embodiment, the polymer comprising phosphorylcholine (and preferably 2-methacryloyloxyethyl phosphorylcholine) further comprises anionic groups. Accordingly, in this embodiment, the MPC is an anionic MPC polymer (polyquaternium-65) with a commercial trade name Lipidure®-A. In this embodiment, the anionic group is the sodium salt of carboxylic acid. The chemical name of this polymer is 2-methyl-2-propenoyloxyethyl N,N,N-trimethylammonioethyl phosphate inner salt, polymer with butyl 2-methyl-2-propenoate and sodium 2-methyl-2-propenoate.

Accordingly, in one embodiment, the polymer comprising 2-methacryloyloxyethyl phosphorylcholine has the formula (IV):

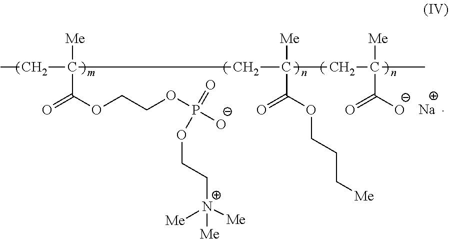

In another embodiment, the polymer comprising phosphorylcholine (and preferably 2-methacryloyloxyethyl phosphorylcholine) further comprises hydrogen-bonding groups. Advantageously, this polymer produces a water retaining gel membrane on surfaces. This MPC polymer is a synthetic lipid polymer designed for biocompatible surfaces for hemo-compatibility, anti-adhesion of proteins and cells, anti-denaturing of proteins, and anti-activation of cells. The trade name of the polymer is Lipidure®-MF3 or Lipidure GA10. In this embodiment, the hydrogen-bonding group is hydroxyl or carboxylic acid.

In yet another embodiment, the polymer comprising phosphorylcholine (and preferably 2-methacryloyloxyethyl phosphorylcholine) further comprises hydrophobic groups. Accordingly, in this embodiment, the MPC polymer is a hydrophobic MPC polymer, (polyquaternium 51) with a commercial trade name Lipidure®-PMB. In this embodiment, the hydrophobic group is an alkyl group, including but not limited to n-butyl or octadecyl.

In one embodiment, the hydrophobic group is n-butyl methacrylate. The chemical name of this polymer is 2-(N,N,N-Trimethylamino)ethyl 2-(2-methyl-2-propenoyloxy)ethyl phosphate inner salt, polymer with butyl 2-methyl-2-propenoate. Accordingly, in one embodiment, the polymer comprising 2-methacryloyloxyethyl phosphorylcholine has the formula (V):

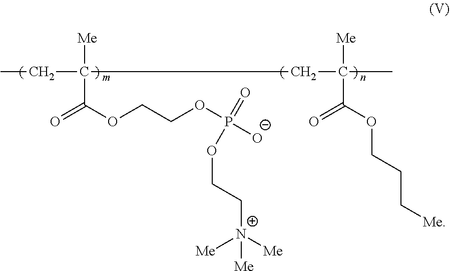

Alternatively, in another embodiment, the polymer comprising phosphorylcholine (and preferably 2-methacryloyloxyethyl phosphorylcholine) forms nanoparticles. Advantageously, due to the nanoparticle structure formed on the material it is applied to, a water repelling layer is formed on the surface. Accordingly, in this embodiment, the MPC polymer is a nanoparticle MPC polymer (Polyquaternium-61) with a commercial trade name Lipidure®-NA and Lipidure®-NS.

In one embodiment, the polymer forming nanoparticles comprises octadecyl 2-methyl-2-propenoate. The chemical name of this polymer is 2-Methyl-2-propenoyloxyethyl N,N,N-trimethylammonioethyl phosphate inner salt, polymer with octadecyl 2-methyl-2-propenoate. Accordingly, in one embodiment, the polymer comprising 2-methacryloyloxyethyl phosphorylcholine has the formula (VI):

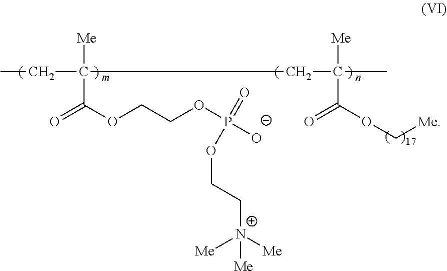

Accordingly, in a preferred embodiment, the polymer comprising phosphorylcholine (preferably 2-methacryloyloxyethyl phosphorylcholine), forms a water retaining gel membrane or a water repelling layer.

In one embodiment, the polymer may be in a composition comprising deionised water. In this embodiment, the composition may comprise at least 1% (v/v) or at least 2% (v/v) polymer, preferably 2-methacryloyloxyethyl phosphorylcholine. In another embodiment, the composition comprises at least 5% (v/v), at least 10% (v/v), at least 15% (v/v), at least 20% (v/v), at least 25% (v/v), at least 30% (v/v), at least 35% (v/v), at least 40% (v/v), at least 45% (v/v), at least 50% (v/v), at least 55% (v/v), at least 60% (v/v), at least 65% (v/v), at least 70% (v/v), at least 75% (v/v), at least 80% (v/v), at least 85% (v/v), at least 90% (v/v), or at least 95% (v/v) polymer, preferably 2-methacryloyloxyethyl phosphorylcholine.

In a preferred embodiment, the composition comprises between 0.5% and 15% (v/v) polymer, preferably 2-methacryloyloxyethyl phosphorylcholine, and deionised water. Preferably, the composition comprises between 1% and 12% (v/v) polymer, more preferably between 2% and 8% (v/v) polymer, and most preferably between 4% and 6% (v/v) polymer, preferably 2-methacryloyloxyethyl phosphorylcholine, and deionised water. In a preferred embodiment, however, the composition comprises about 5% (v/v) polymer, preferably 2-methacryloyloxyethyl phosphorylcholine, and deionised water.

Alternatively, in another embodiment, the composition consists of 100% (v/v) polymer, preferably 2-methacryloyloxyethyl phosphorylcholine.

In one embodiment, the composition may comprise less than 99% (v/v) or less than 98% (v/v) deionised water. In another embodiment, the composition comprises less than 95% (v/v), less than 90% (v/v), less than 85% (v/v), less than 80% (v/v), less than 75% (v/v), less than 70% (v/v), less than 65% (v/v), less than 60% (v/v), less than 55% (v/v), less than 50% (v/v), less than 45% (v/v), less than 40% (v/v), less than 35% (v/v), less than 30% (v/v), less than 25% (v/v), less than 20% (v/v), less than 15% (v/v), less than 10% (v/v), or less than 5% (v/v) deionised water. Alternatively, in another embodiment, the composition does not comprise deionised water.

Alternatively, in another embodiment, the polymer may be in a composition comprising alcohol. In this embodiment, the composition may comprise at least 1% (v/v) or at least 2% (v/v) polymer, preferably 2-methacryloyloxyethyl phosphorylcholine. In another embodiment, the composition comprises at least 5% (v/v), at least 10% (v/v), at least 15% (v/v), at least 20% (v/v), at least 25% (v/v), at least 30% (v/v), at least 35% (v/v), at least 40% (v/v), at least 45% (v/v), at least 50% (v/v), at least 55% (v/v), at least 60% (v/v), at least 65% (v/v), at least 70% (v/v), at least 75% (v/v), at least 80% (v/v), at least 85% (v/v), at least 90% (v/v), or at least 95% (v/v) polymer, preferably 2-methacryloyloxyethyl phosphorylcholine.

In a preferred embodiment, the composition comprises between 30% and 70% (v/v) polymer, preferably 2-methacryloyloxyethyl phosphorylcholine, and alcohol. Preferably, the composition comprises between 40% and 60% (v/v) polymer, more preferably between 45% and 55% (v/v) polymer, and most preferably between 48% and 52% (v/v) polymer, preferably 2-methacryloyloxyethyl phosphorylcholine, and alcohol. In a preferred embodiment, however, the composition comprises about 50% (v/v) polymer, preferably 2-methacryloyloxyethyl phosphorylcholine, and alcohol. Preferably, the alcohol is ethanol.

In one embodiment, the composition may comprise less than 99% (v/v) or less than 98% (v/v) alcohol. In another embodiment, the composition comprises less than 95% (v/v), less than 90% (v/v), less than 85% (v/v), less than 80% (v/v), less than 75% (v/v), less than 70% (v/v), less than 65% (v/v), less than 60% (v/v), less than 55% (v/v), less than 50% (v/v), less than 45% (v/v), less than 40% (v/v), less than 35% (v/v), less than 30% (v/v), less than 25% (v/v), less than 20% (v/v), less than 15% (v/v), less than 10% (v/v), or less than 5% (v/v) alcohol. Preferably, the alcohol is ethanol.

In one embodiment, the polymer comprising phosphorylcholine (preferably 2-methacryloyloxyethyl phosphorylcholine) is heated. Preferably, the polymer is heated with an air drier after application to the surface. Even more preferably, the polymer is heated with an air drier for at least 20 seconds, at least 30 seconds, at least 40 seconds, at least 50 seconds, or at least 60 seconds.

In one preferred embodiment, the polymer comprising phosphorylcholine is pre-formed prior to contacting the surface. As such, the claimed invention does not require polymerisation of monomers in situ to form a polymer on the surface.

In one embodiment, the dimethicone copolyol is selected from an alkyl- and alkoxy-dimethicone copolyol having the formula (VII):

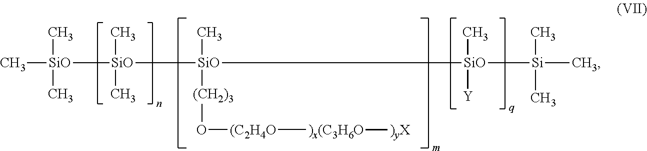

wherein X is selected from the group consisting of hydrogen, alkyl, alkoxy and acyl groups having from about 1 to about 16 carbon atoms, Y is selected from the group consisting of alkyl and alkoxy groups having from about 8 to about 22 carbon atoms, n is from about 0 to about 200, m is from about 1 to about 40, q is from about 1 to about 100, the molecular weight of the residue (C₂H₄O—)ₓ—(C₃H₆O—)_{y}X is from about 50 to about 2000, and x and y are such that the weight ratio of oxyethylene:oxypropylene is from about 100:1 to about 0:100.

In preferred embodiments, the dimethicone copolyol is selected from C₁₂ to C₂₀ alkyl dimethicone copolyols and mixtures thereof.

In a most preferred embodiment, the dimethicone copolyol is cetyl dimethicone coplyol. Cetyl dimethicone coplyol is a modified siloxane co-polymer, manufactured by Evonik Industries AG, Rellinghauser Straße 1-11, 45128 Essen, Germany and marketed under the Trade Name Abil EM90 [7].

The dimethicone copolyol may be referred to as an alkyl pendently grafted polymer that hinders attachment by virtue of the projecting alkyl groups. The dimethicone copolyol acts as a block polymer that has alternating groups that project out from the surface, preventing attachment. As such, careful selection is required since the size of the pendent groups and their chemistry is important to achieve the benefit, preventing attachment of fouling organisms. Accordingly, in a preferred embodiment, the dimethicone copolyol prevents fouling and/or corrosion by an alkyl pendently grafted polymer that hinders attachment by virtue of the projecting alkyl groups.

In one embodiment, the dimethicone copolyol may be in a composition comprising deionised water. It will be appreciated by the skilled person that the dimethicone copolyol does not dissolve in water, but rather forms a dispersion or emulsion. In this embodiment, the composition may comprise at least 1% (v/v) or at least 2% (v/v) dimethicone copolyol, preferably cetyl dimethicone coplyol. In another embodiment, the composition comprises at least 5% (v/v), at least 10% (v/v), at least 15% (v/v), at least 20% (v/v), at least 25% (v/v), at least 30% (v/v), at least 35% (v/v), at least 40% (v/v), at least 45% (v/v), at least 50% (v/v), at least 55% (v/v), at least 60% (v/v), at least 65% (v/v), at least 70% (v/v), at least 75% (v/v), at least 80% (v/v), at least 85% (v/v), at least 90% (v/v), or at least 95% (v/v) dimethicone copolyol, preferably cetyl dimethicone coplyol. Alternatively, in another embodiment, the composition consists of 100% (v/v) dimethicone copolyol, preferably cetyl dimethicone coplyol.

In one embodiment, the composition may comprise less than 99% (v/v) or less than 98% (v/v) deionised water. In another embodiment, the composition comprises less than 95% (v/v), less than 90% (v/v), less than 85% (v/v), less than 80% (v/v), less than 75% (v/v), less than 70% (v/v), less than 65% (v/v), less than 60% (v/v), less than 55% (v/v), less than 50% (v/v), less than 45% (v/v), less than 40% (v/v), less than 35% (v/v), less than 30% (v/v), less than 25% (v/v), less than 20% (v/v), less than 15% (v/v), less than 10% (v/v), or less than 5% (v/v) deionised water. Alternatively, in another embodiment, the composition does not comprise deionised water.

Alternatively, in another embodiment, the dimethicone copolyol may be in a composition comprising alcohol. In this embodiment, the composition may comprise at least 1% (v/v) or at least 2% (v/v) dimethicone copolyol, preferably cetyl dimethicone copolyol. In another embodiment, the composition comprises at least 5% (v/v), at least 10% (v/v), at least 15% (v/v), at least 20% (v/v), at least 25% (v/v), at least 30% (v/v), at least 35% (v/v), at least 40% (v/v), at least 45% (v/v), at least 50% (v/v), at least 55% (v/v), at least 60% (v/v), at least 65% (v/v), at least 70% (v/v), at least 75% (v/v), at least 80% (v/v), at least 85% (v/v), at least 90% (v/v), or at least 95% (v/v) dimethicone copolyol, preferably cetyl dimethicone copolyol.

In one embodiment, the composition may comprise less than 99% (v/v) or less than 98% (v/v) alcohol. In another embodiment, the composition comprises less than 95% (v/v), less than 90% (v/v), less than 85% (v/v), less than 80% (v/v), less than 75% (v/v), less than 70% (v/v), less than 65% (v/v), less than 60% (v/v), less than 55% (v/v), less than 50% (v/v), less than 45% (v/v), less than 40% (v/v), less than 35% (v/v), less than 30% (v/v), less than 25% (v/v), less than 20% (v/v), less than 15% (v/v), less than 10% (v/v), or less than 5% (v/v) alcohol.

In one embodiment, the dimethicone copolyol is heated. Preferably, the polymer is heated with an air drier after application to the surface. Even more preferably, the polymer is heated with an air drier for at least 20 seconds, at least 30 seconds, at least 40 seconds, at least 50 seconds, or at least 60 seconds.

The inventor also surprisingly discovered that a polymer comprising phosphorylcholine and/or dimethicone copolyol, when combined with a ceramic coating, provides an improved anti-fouling and/or anti-corrosive agent.

Thus, according to a third aspect of the invention, there is provided a composition comprising a ceramic coating, and a (i) polymer comprising phosphorylcholine and/or (ii) dimethicone copolyol.

Preferably, the polymer comprising phosphorylcholine and/or dimethicone copolyol are as described above.

It will be appreciated that the term ‘ceramic coating’ used throughout means a silicone coating. It is well-known to the skilled person that ceramic coatings may also be referred to as glass coatings, nano coatings, silica coatings and/or hydrophobic coatings. For example, the term ceramic coating is well known in the automotive sector and may be defined as a liquid polymer that is applied to the exterior of a vehicle, wherein the coating chemically bonds with the vehicle's paint, creating a layer of protection. A ceramic coating, as referred to herein, may be defined as a semi-permanent, non-metallic, inorganic, protective clear coat [9,10,11].

In one embodiment, the ceramic coating comprises a resin (polymer). Preferably, the resin is a silicone-based polymer (polysiloxane). Silicone-based polymers contain alternating silicon and oxygen atoms in the backbone. Common polymers in this family are poly(organo)siloxanes, i.e. polysiloxanes with organic substituents. Although called silanes, monomeric silicon-based molecules, such as those used as adhesion promoters in many multi-layered systems, are a special category of siloxanes, since they usually contain oxygen attached to the silicon atom. For example, in one embodiment, the resin may be polydimethylsiloxanes (PDMS). Advantageously, silicone-based polymers such as PDMS are non-toxic, inert, non-flammable, optically clear with excellent thermal properties and are UV stable. Preferably, PDMS provides the hard, glossy and hydrophobic characteristics. In another embodiment, the resin is dimethyl, (Aminoethylaminopropyl)methyl siloxane, trimethylsiloxy-terminated at approximately 5-10%.

In one embodiment, the ceramic coating comprises at least one solvent. Preferably, the solvent is naptha (petroleum) hydrotreated Heavy (60-100%), distillates (petroleum) hydrotreated light (30-60%), or decamethylcyclopentasiloxane (5-10%).

In one embodiment, ceramic coating comprises at least one additive. The additive may be a silane additive. Silane additives form covalent bonds with the surface to which the ceramic coating is applied, to form a semi-permanent thin protective film. The silane functional group (—Si—O—R) reacts with the surface to form a strong covalent bond. This is important for the substantivity and durability of the ceramic coating.

In a preferred embodiment, the ceramic coating comprises a resin (polymer), a solvent(s) and an additive.

In another embodiment, the ceramic coating further comprises titanium dioxide (TiO2) and/or Zinc Oxide (ZnO). Advantageously, the titanium dioxide provides UV resistance and protection from harsh sunlight. Preferably, the ceramic coating comprises between 0 and 60% titanium dioxide, more preferably between 1 and 10% titanium dioxide. Preferably, the ceramic coating comprises between 0 and 5% zinc oxide, more preferably between 1 and 5% zinc oxide.

In one embodiment, the ceramic coating consists of 60% Naptha (petroleum) Hydrotreated Heavy, 30% Distillates (petroleum) hydrotreated light, 5% decamethylcyclopentasiloxane, and 5% Titanium dioxide (TiO2).

In another embodiment, the ceramic coating consists of 60% Naptha (petroleum) Hydrotreated Heavy, 30% Distillates (petroleum) hydrotreated light, and 10% decamethylcyclopentasiloxane.

In another embodiment, the ceramic coating consists of 45% Naptha (petroleum) Hydrotreated Heavy, 45% Distillates (petroleum) hydrotreated light, 8% decamethylcyclopentasiloxane, and 2% Zinc Oxide (ZnO).

In other embodiments, the ceramic coating comprises 30-60% Naptha (petroleum), 30-60% distillates, 5-10% dimethyl(aminopropyl)methyl siloxane trimethylsiloxy terminated, and 5-10% decamethylcyclopentasiloxane.

In further embodiments, the ceramic coating comprises 30-60% distillates, 5-10% dimethyl(aminopropyl)methyl siloxane trimethylsiloxy terminated, and 30-60% C9-C11 hydrocarbons, n-alkanes, isoalkanes, and cyclics.

The hardness of the ceramic coating is dependent on the crosslinking agents in the formula. Without the addition of the crosslinking agent into the ceramic coating system, the monomer will tend to react along the main chain, forming a longer chain with minimal crosslinking. This results in coatings with only moderate hardness. Accordingly, in a preferred embodiment, the ceramic coating comprises a crosslinking agent. In one embodiment, the crosslinking agent is dimethyl, (Aminoethylaminopropyl)methyl siloxane, trimethylsiloxy-terminated at approximately 5-10% It will be appreciated that this crosslinking agent is a silane, whose molecules contain functional groups that bond with both organic and inorganic materials. A silane coupling agent acts as an intermediary which bonds organic materials to inorganic materials. Preferably, crosslinking occurs by hydrolysis.

Alternatively, in another embodiment, crosslinking occurs by activation, for example, by light, UV or heat.

In one embodiment, the composition comprises a ratio of polymer comprising phosphorylcholine to ceramic coating from about 1:10 to about 10:1 by volume. Preferably, the composition comprises a ratio of polymer comprising phosphorylcholine to ceramic coating of about 1:3 by volume.

In another embodiment, the composition comprises a ratio of dimethicone copolyol to ceramic coating from about 1:10 to about 10:1 by volume. Preferably, the composition comprises a ratio of dimethicone copolyol to ceramic coating of about 1:3 or about 1:2 by volume.

In one embodiment, the composition consists of 37% Naptha (petroleum) Hydrotreated Heavy, 19% Distillates (petroleum) hydrotreated light, 6% decamethylcyclopentasiloxane, and 38% cetyl dimethicone copolyol (CDC).

In another embodiment, the composition consists of 37% Naptha (petroleum) Hydrotreated Heavy, 19% Distillates (petroleum) hydrotreated light, 6% decamethylcyclopentasiloxane, and 38% 2-methacryloyloxyethyl phosphorylcholine (MPC).

In another embodiment, the composition consists of 37% Naptha (petroleum) Hydrotreated Heavy, 19% Distillates (petroleum) hydrotreated light, 6% decamethylcyclopentasiloxane, 19% cetyl dimethicone copolyol (CDC), and 19% 2-methacryloyloxyethyl phosphorylcholine (MPC).

The composition according to the third aspect may further comprise water. Accordingly, in one embodiment, the composition comprises a ceramic coating, water, and a (i) polymer comprising phosphorylcholine and/or (ii) dimethicone copolyol. More preferably, the composition comprises a ceramic coating, water, a polymer comprising phosphorylcholine and dimethicone copolyol.

Preferably, the composition comprises between 30% and 70% (v/v) water. Preferably, the composition comprises between 40% and 60% (v/v) water, more preferably between 45% and 55% (v/v) water, and most preferably between 48% and 52% (v/v) water. Preferably, the composition comprises about 50% (v/v) of water.

Advantageously, this composition comprises no biocides and no metal ions including zinc or copper. A clear thin film coating of the composition can be applied, such that it has a good visual appearance. As discussed in the Examples, the inventor has demonstrated that this composition advantageously modifies the surface properties to prevent fouling and corrosion.

In one preferred embodiment, the composition according to the third aspect comprises three parts cetyl dimethicone copolyol, to three parts 2-methacryloyloxyethyl phosphorylcholine, to ten parts ceramic coating, to ten parts water.

In one embodiment, the composition according to the third aspect is heated. Preferably, the polymer is heated with an air drier after application to the surface. Even more preferably, the polymer is heated with an air drier for at least 20 seconds, at least 30 seconds, at least 40 seconds, at least 50 seconds, or at least 60 seconds.

In a fourth aspect of the invention, there is provided a use of the composition according to the third aspect, as an anti-fouling and/or anti-corrosive agent.

In a fifth aspect of the invention, there is provided a method of protecting a surface from fouling and/or corrosion, comprising contacting the surface with the composition according to the third aspect.

In one embodiment, the method according to the fifth aspect comprises first coating the surface with a primer. Preferably, the primer comprises cetyl dimethicone copolyol and a ceramic coating. More preferably, the primer comprises three parts cetyl dimethicone copolyol and ten parts ceramic coating. Advantageously, this primer provides chemical binding to the surface by the silane in the ceramic coating, thereby extending the coating duration by attaching more strongly to the surface.

The term “fouling” will be well-known to the skilled person, and can be defined as the accumulation of microorganisms, plants, algae, algal spores, marine fungi, protozoa, or small animals and invertebrates, such as soft corals, sponges, anemones, tunicates, hydroids, barnacles, barnacle cyprids, mussels and tubeworms, on surfaces exposed to water. The term “anti-fouling” or “fouling prevention and release system” will also be known to skilled person and can be defined as an agent or composition which is designed to remove, ease removal, or prevent fouling on surfaces exposed to water.

Accordingly, in a preferred embodiment, the use of the polymer and/or composition according to the first and fourth aspects, and the methods of the second and fifth aspects, prevent the adhesion of fouling organisms, such as proteins, cells, microorganisms, algae, plants, and/or animals.

The term “fouling” may also include both “hard fouling” and “soft fouling”. Hard fouling may comprise invertebrates such as barnacles, mussels and tubeworms. Soft fouling may comprise algae and invertebrates, such as soft corals, sponges, anemones, tunicates and hydroids.

Thus, in a preferred embodiment, the use of the polymer and/or composition according to the first and fourth aspects, and the methods of the second and fifth aspects, prevent hard fouling and/or soft fouling.

The term “corrosion” will be well-known to the skilled person, and may be defined as the oxidisation of atoms on a metal surface, resulting in damage to the surface. Thus, the term “anti-corrosive” as used herein, may be defined as the protection of metal surfaces from the occurrence and progression of corrosion.

The inventor has also surprisingly discovered that the polymer coatings and compositions according to the invention surprisingly reduce drag (and improves lift in the water) on boats, and therefore, results in reduced fuel consumption and increased speed.

Accordingly, in a sixth aspect, there is provided use of:
(i) a polymer comprising phosphorylcholine and/or dimethicone copolyol, or
(ii) a composition comprising a ceramic coating, and a (a) polymer comprising phosphorylcholine and/or (b) dimethicone copolyol,
as a drag-reducing agent.

In a seventh aspect of the invention, there is provided a method of reducing drag on a surface, the method comprising contacting the surface with:
(i) a polymer comprising phosphorylcholine and/or dimethicone copolyol, or
(ii) a composition comprising a ceramic coating, and a (a) polymer comprising phosphorylcholine and/or (b) dimethicone copolyol.

As described herein, drag refers to the force acting opposite to the relative motion of an object moving with respect to a surrounding fluid (e.g. water). In addition to acting as a drag-reducing agent, lift of an object in the fluid (e.g. water) is also preferably increased.

Preferably, the methods according to the second, fifth or seventh aspects, comprise contacting the surface with the polymer and/or composition by spraying, painting, directly applying with an applicator (such as a pad or roller, e.g. a foam pad, or a foam roller) and/or dip coating. The applied coating may then be brushed to obtain a smooth finish.

In one embodiment, the method according to the fifth or seventh aspect comprises mixing the polymer comprising phosphorylcholine and/or dimethicone copolyol, and the ceramic coating on the surface, i.e. in situ. Alternatively, in another embodiment, the method comprises mixing the polymer comprising phosphorylcholine and/or dimethicone copolyol, and the ceramic coating prior to contacting the surface.

Preferably, the methods according to the second, fifth or seventh aspects further comprise drying the polymer and/or composition on the surface. In a preferred embodiment, the methods comprise drying the polymer and/or composition on the surface at ambient room temperature, preferably above 8° C., or even more preferably above 15° C.

Ceramic coatings are dry-to-touch within hours, but the full curing (i.e. hardening) process usually takes between 5 to 7 days. Accordingly, in a preferred embodiment, the method according to the fifth or seventh aspect further comprises curing the composition on the surface for at least one day, at least two days, at least three days, at least four days, at least five days, at least six days, or at least seven days.

The surface may be the surface of a material selected from fibreglass, carbon fibre, graphene, glass, ceramic, acrylic, stone, polyethylene, wood, plastic (such as nylon, PET, PMMA, PU, PC, PE and PP), synthetic rubbers, or metals including steel, stainless steel, aluminium, titanium copper, gold, or silver and alloys of metal e.g. brass and bronze

In a preferred embodiment, the dimethicone copolyol (preferably the cetyl dimethicone copolyol) is applied to the surface of fibreglass and/or stainless steel. In another preferred embodiment, the composition comprising dimethicone copolyol (preferably cetyl dimethicone copolyol) and a ceramic coating, is applied to the surface of fibreglass and/or stainless steel.

In another preferred embodiment, the polymer comprising phosphorylcholine (preferably 2-methacryloyloxyethyl phosphorylcholine) is applied to the surface of fibreglass, stainless steel and/or nylon. In another preferred embodiment, the composition comprising a polymer comprising phosphorylcholine (preferably 2-methacryloyloxyethyl phosphorylcholine) and a ceramic coating, is applied to the surface of fibreglass, stainless steel and/or nylon.

In another embodiment, the polymer and/or composition is applied to the surface of marine equipment. Marine equipment may include vessels, ships, boats, tankers, barges, submersibles, hulls (e.g. fibreglass hulls and painted or varnished wooden hulls), engines, hydraulic lifters, mountings, a transom, engine mounting brackets, an outboard motor, propellers, rigging, masts, eyelets, mooring cleats, cables, anchors, ropes, fishing nets, buoys, chains, rudders, structures, mooring, diving equipment, below-sea windows, underwater lighting, wave power generation systems, wind turbines and/or solar panels.

The application of the claimed composition to engines and hydraulic lifters is significantly advantageous because traditional biocide anti-foul products containing metal ions are not suitable for engines or lifters since they can form a galvanic cell with the metal components. This can result in galvanic corrosion of the engine components, in which one metal corrodes when it is in electrical contact with another, in the presence of an electrolyte e.g. sea water, whereas, the claimed composition is formulated without metal ions, allowing it to be used on engines and lifters and other such structures which require protection since it will not form a galvanic cell. Accordingly, in one preferred embodiment, the polymer and/or composition is applied to the surface of engines and/or hydraulic lifters.

Alternatively, in another embodiment, the polymer and/or composition is applied to the surface of bathroom fittings, including showers, baths, sinks, glass fittings, tiles, and/or taps, or to automotive, commercial or domestic glass and/or windows. Alternatively, in another embodiment, the composition is applied to garden patios or garden furniture.

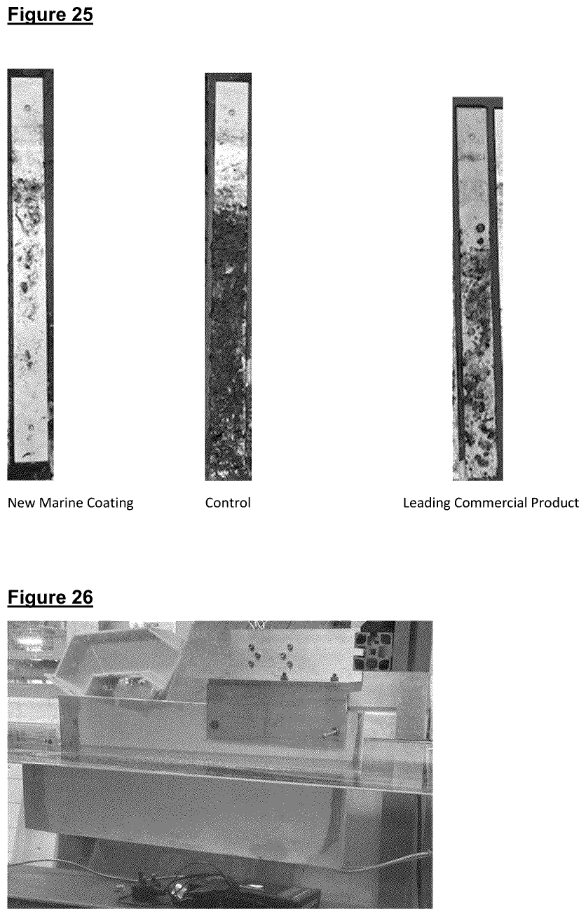

The inventors have found that the compositions of the invention not only prevent fouling and corrosion, they also significantly improve the ease of cleaning of the surface. As shown in FIG. 25, cleaning of stainless steel with a power washer was much quicker and easier if the steel had been coated with the compositions of the invention compared to no treating or treating with a prior art formulation.

In a preferred embodiment, the polymer and/or composition is applied to a non-therapeutic environment, i.e. a non-human environment. Preferably, the polymer and/or composition is not for use as an oral care composition.

Preferably, the polymer and/or composition is not for use in airborne fine particulate adhesion prevention (e.g. pollen).

All of the features described herein (including any accompanying claims, abstract and drawings), and/or all of the steps of any method or process so disclosed, may be combined with any of the above aspects in any combination, except combinations where at least some of such features and/or steps are mutually exclusive.

For a better understanding of the invention, and to show how embodiments of the same may be carried into effect, reference will now be made, by way of example, to the accompanying Figures, in which:—

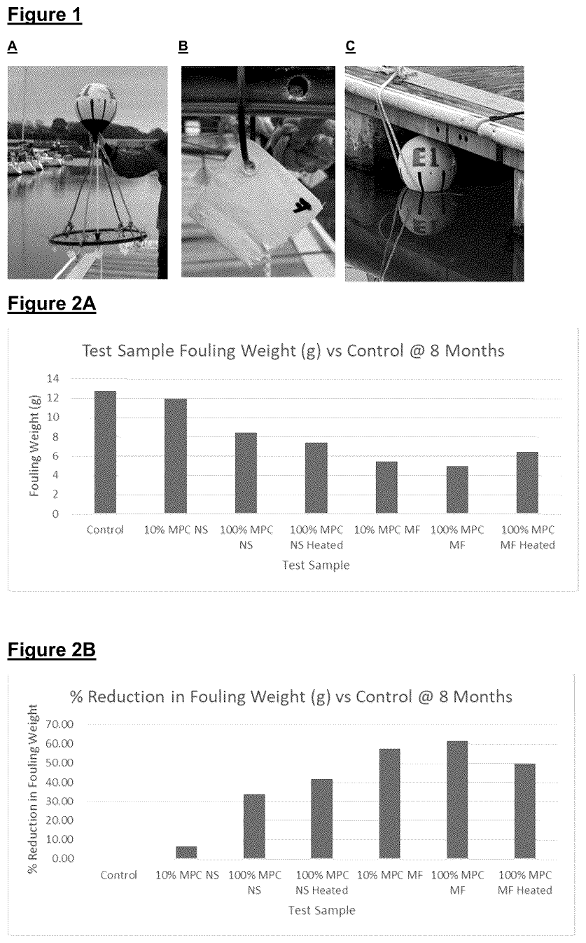

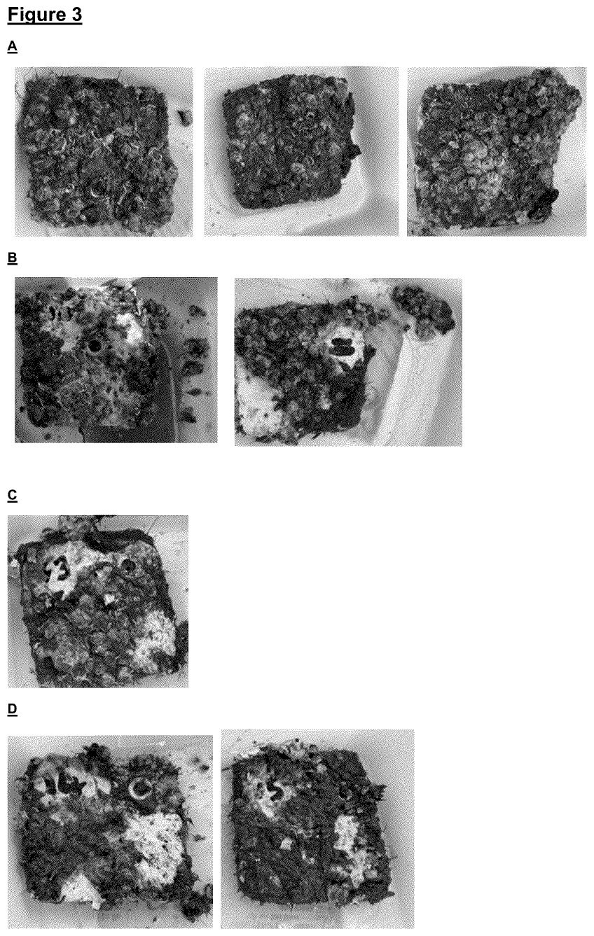

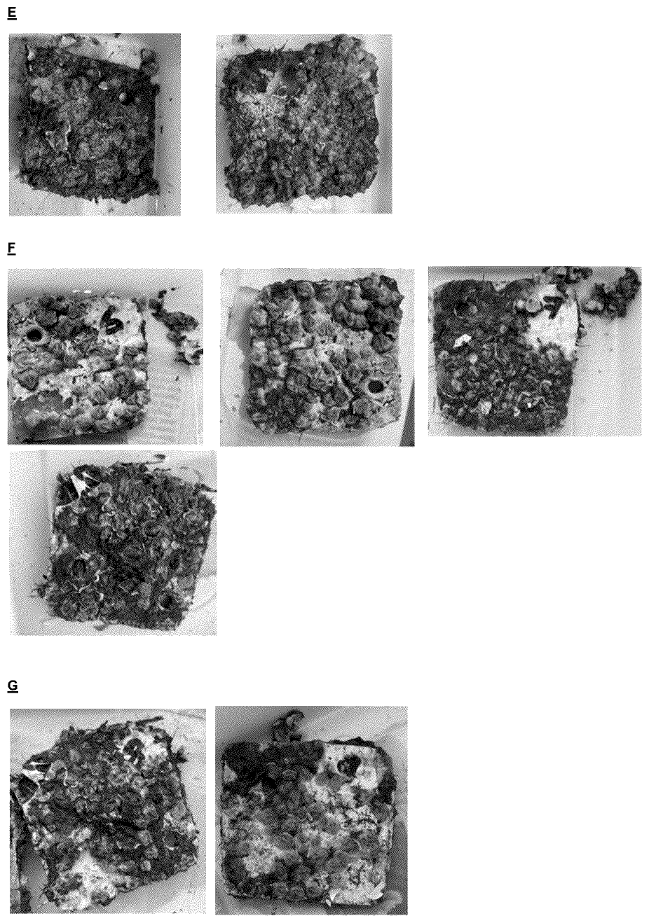

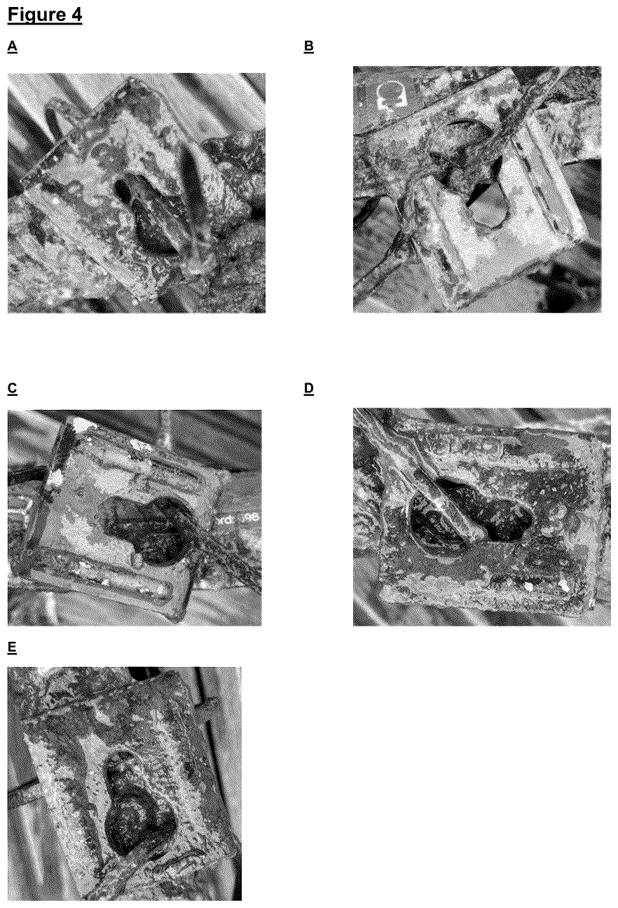

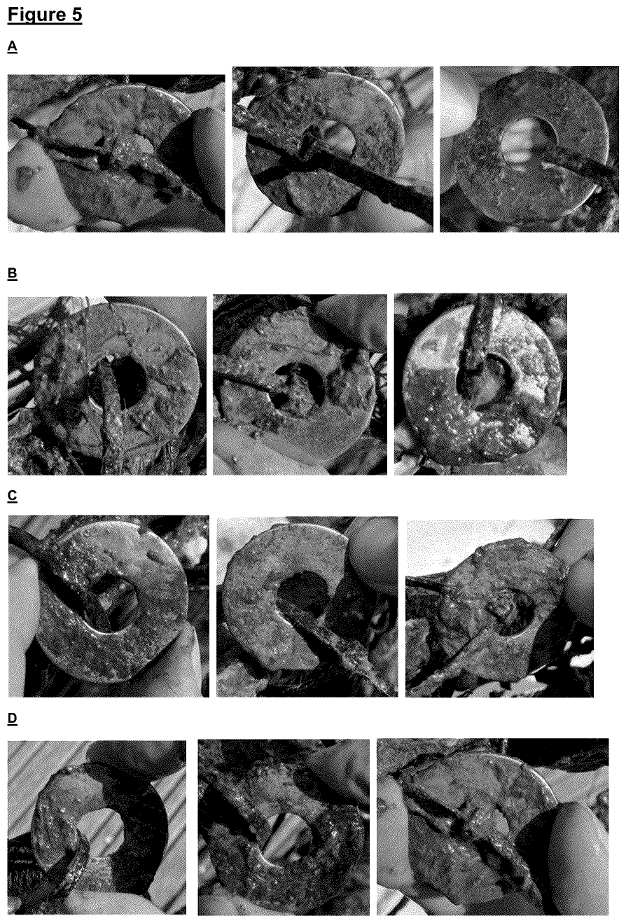

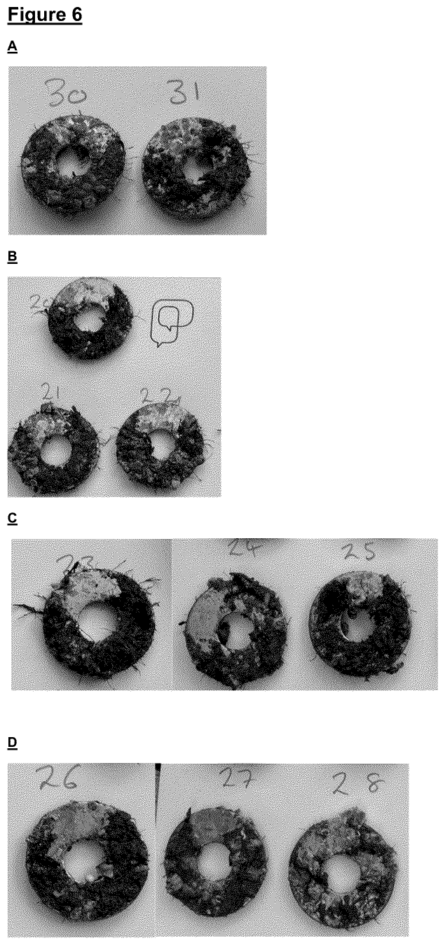

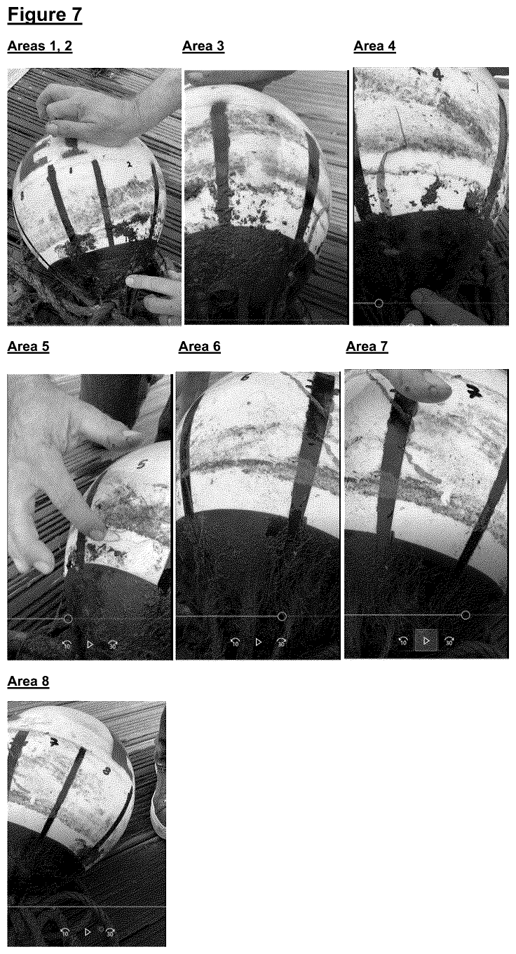

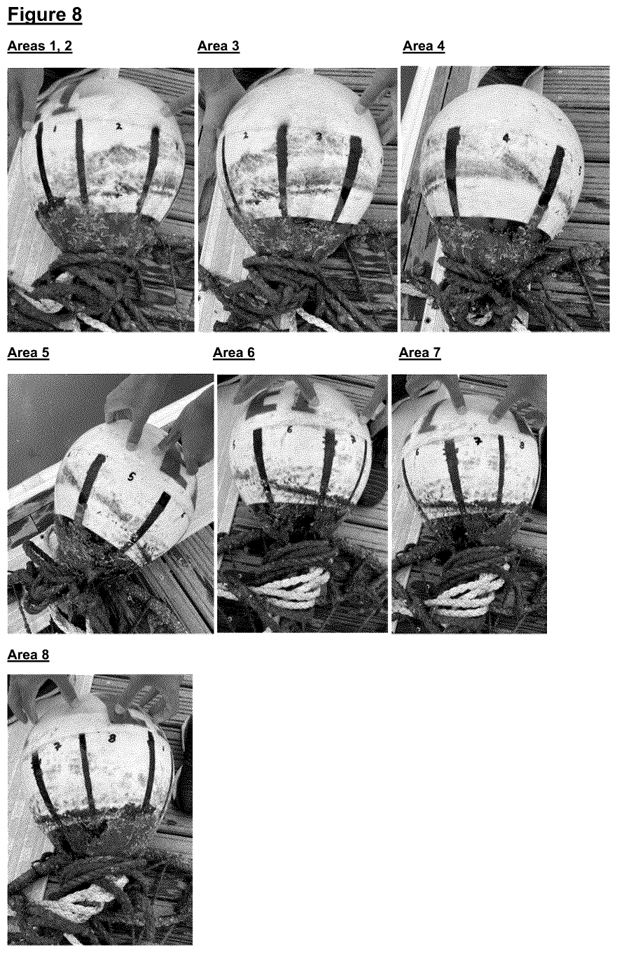

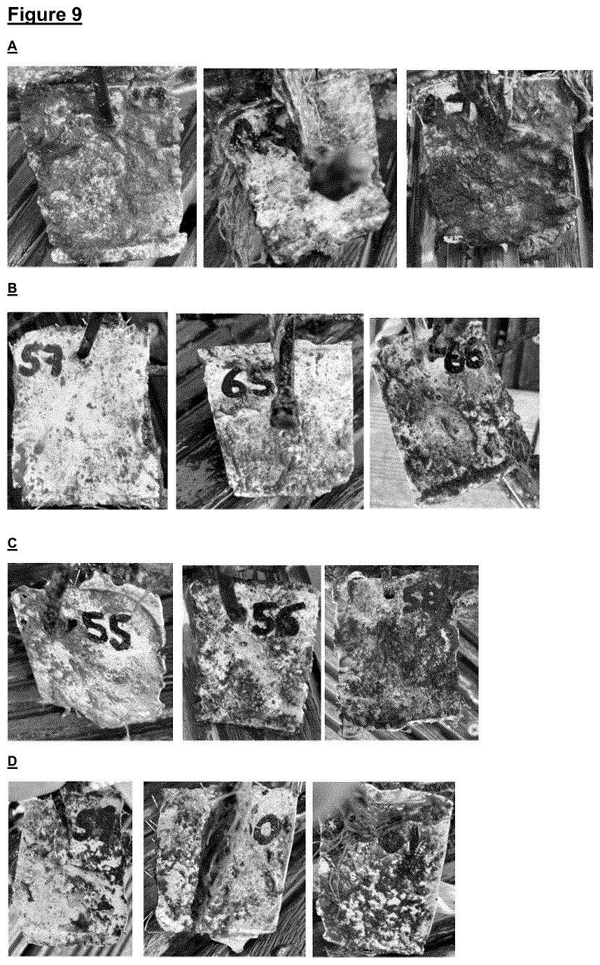

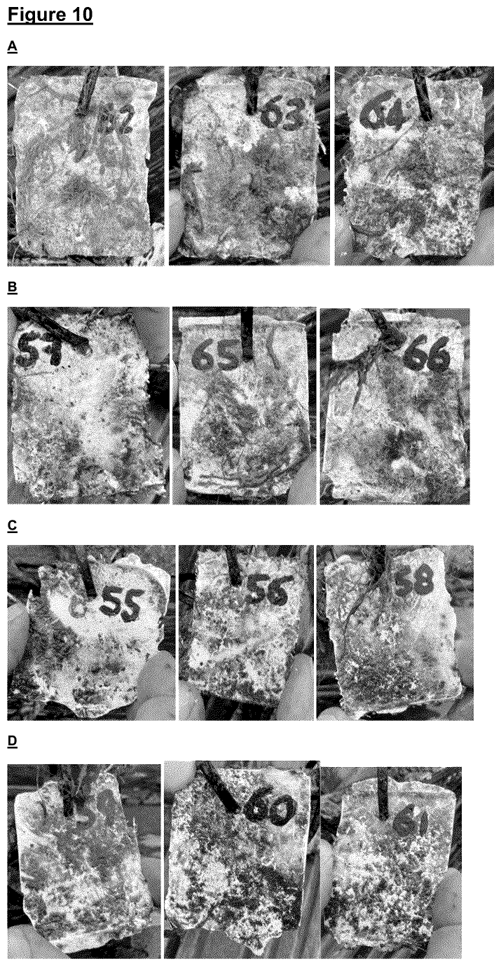

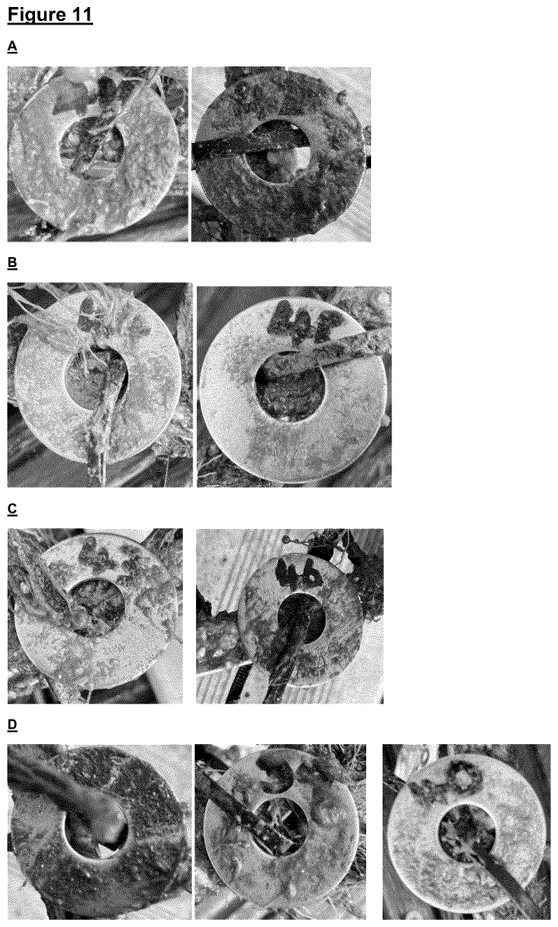

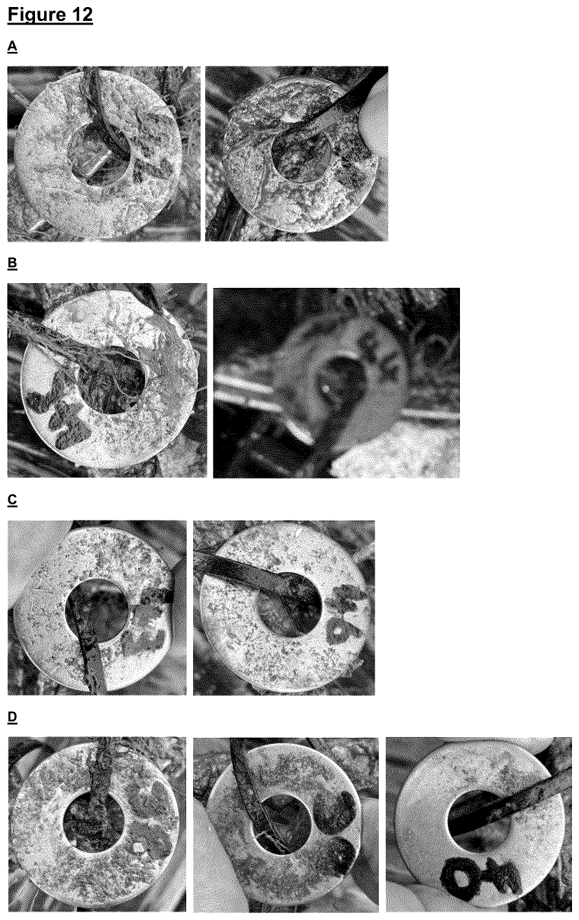

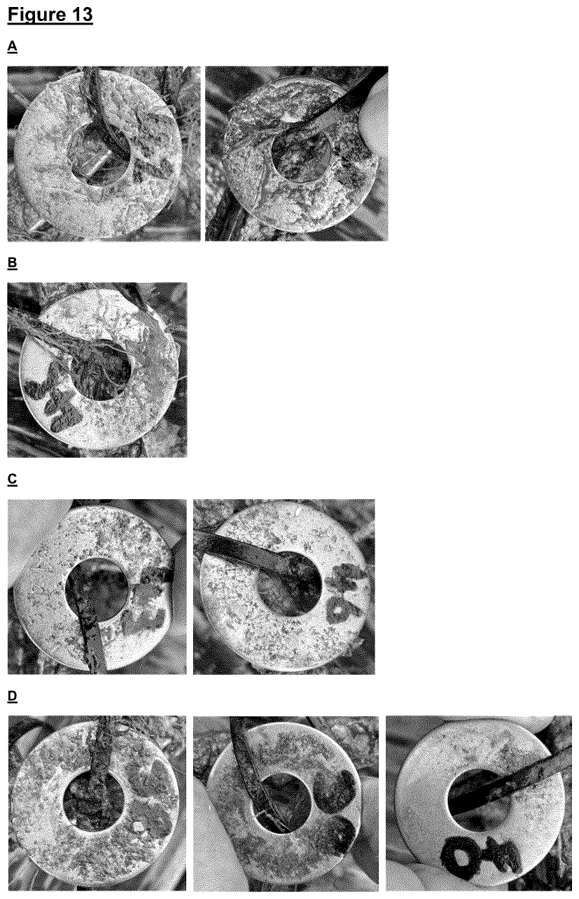

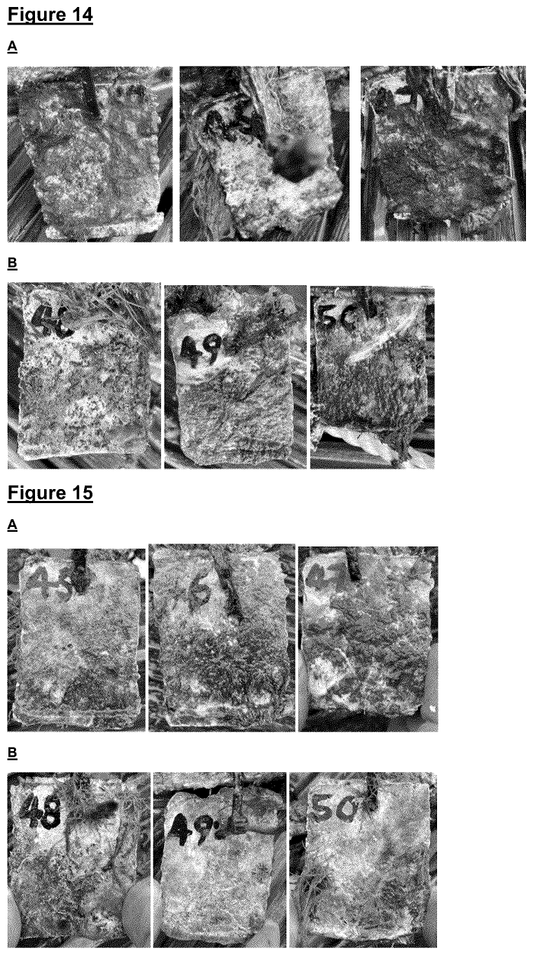

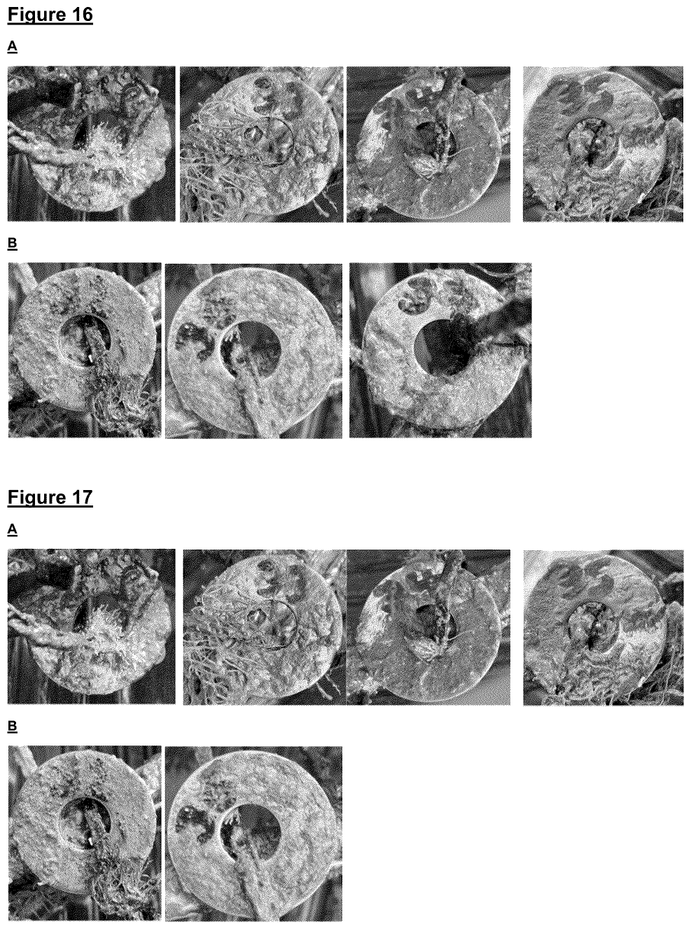

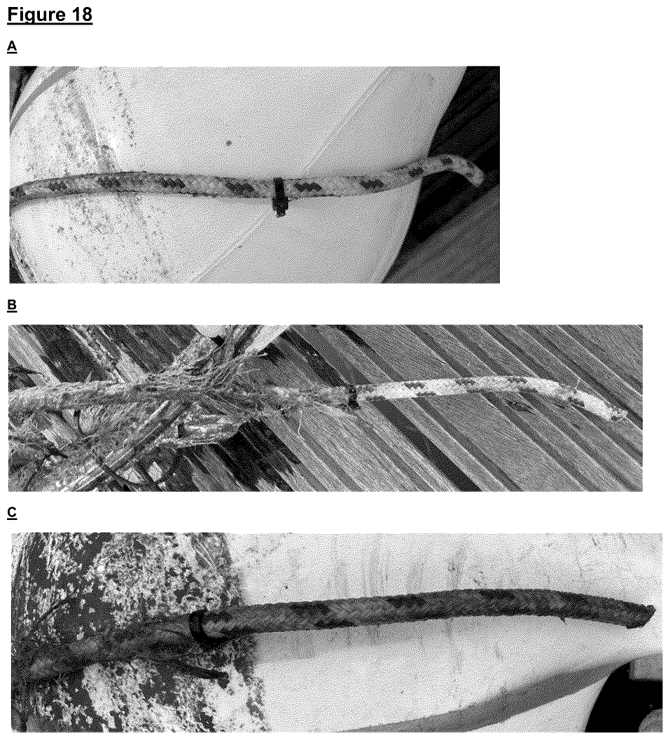

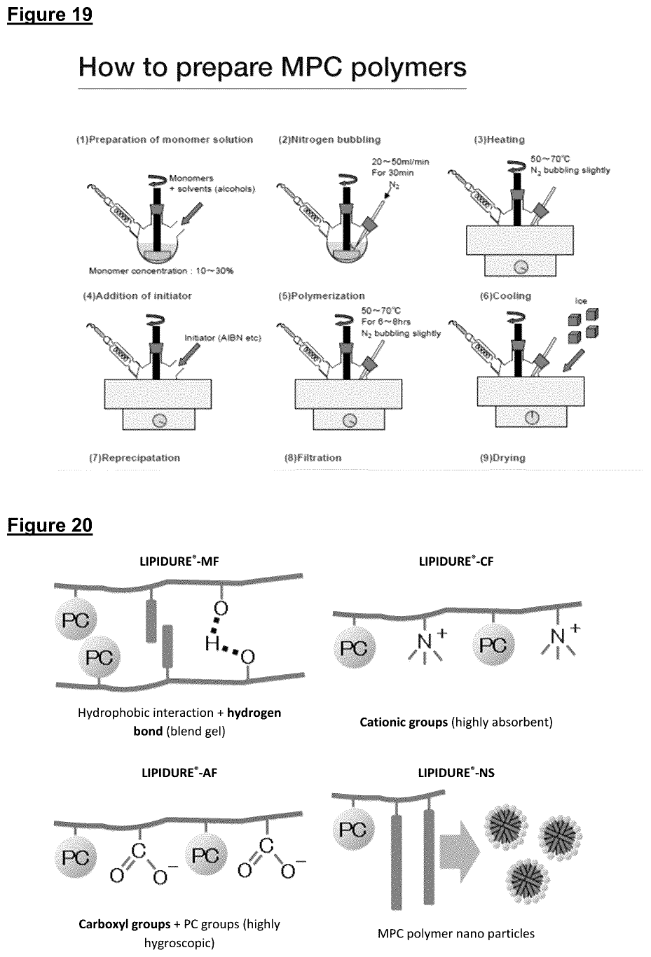

FIG. 1 shows images of a test apparatus used to evaluate 2-methacryloyloxyethyl phosphorylcholine (MPC) polymers. (A) shows a buoy and samples test rig, (B) shows a fibreglass test sample, and (C) shows the test apparatus in tidal water.

FIG. 2A is a bar graph illustrating the weight (g) of the fibreglass treatment samples shown in FIG. 1(B) at 8 months compared to a control. For reference, the average weight of each fibreglass sample is 7.58 grams. FIG. 2B is a bar graph illustrating percent reduction in fouling weight (g) vs control at 8 months.

FIG. 3 shows images of the fibreglass treatment samples shown in FIG. 1(B) at 8 months. (A) shows the untreated negative control samples, (B) shows the samples treated with the polymer comprising 2-methacryloyloxyethyl phosphorylcholine and hydrogen-bonding groups, i.e. hydroxyl or carboxylic acid (referred to herein as MPC MF Polymer) 10% (w/w) solution, (C) shows the sample treated with MPC MF Polymer 100% (w/w) solution, (D) shows the heated samples treated with MPC MF Polymer 100% (w/w) solution, (E) shows the samples treated with the polymer comprising 2-methacryloyloxyethyl phosphorylcholine and octadecyl 2-methyl-2-propenoate (Formula VI), which forms nanoparticles, (referred to herein as MPC NS Polymer), 10% (w/w) solution, (F) shows the samples treated with MPC NS Polymer 100% (w/w) solution, and (G) shows the heated samples treated with MPC NS 100% (w/w) solution.

FIG. 4 shows images of mild steel metal samples at 2 months. (A) shows the negative control sample (untreated), (B) shows the sample treated with 100% (w/w) MPC MF Polymer, (C) shows the sample treated with 10% (w/w) MPC NS Polymer, (D) shows the sample treated with 10% (w/w) MPC MF Polymer, and (E) shows the sample treated with 100% (w/w) MPC NS Polymer.

FIG. 5 shows images of stainless steel samples at 2.5 months. (A) shows the control samples (no treatment), (B) shows the samples treated with 100% (w/w) MPC MF Polymer, (C) shows the samples treated with 25% (w/w) MPC MF Polymer, and (D) shows the samples treated with 10% (w/w) MPC MF Polymer.

FIG. 6 shows images of the stainless steel samples shown in FIG. 5 at 5 months. (A) shows the control samples (no treatment), (B) shows the samples treated with 100% (w/w) MPC MF Polymer, (C) shows the samples treated with 25% (w/w) MPC MF Polymer, and (D) shows the samples treated with 10% (w/w) MPC MF Polymer.

FIG. 7 shows images of the mooring buoy shown in FIG. 1(A) at 6.5 months. Area 1 is the untreated control, Area 2 is 10% (w/w) MPC NS Polymer, Area 3 is 100% MPC NS Polymer, Area 4 is 100% (w/w) MPC MF Polymer Heated, Area 5 is untreated control, Area 6 is 10% (w/w) MPC MF Polymer, Area 7 is 100% (w/w) MPC MF Polymer, and Area 8 is 100% (w/w) MPC MF Polymer Heated.

FIG. 8 shows images of the mooring buoy at 8 months. Area 1 is the untreated control, Area 2 is 10% (w/w) MPC NS Polymer, Area 3 is 100% MPC NS Polymer, Area 4 is 100% (w/w) MPC MF Polymer Heated, Area 5 is untreated control, Area 6 is 10% (w/w) MPC MF Polymer, Area 7 is 100% (w/w) MPC MF Polymer, and Area 8 is 100% (w/w) MPC MF Polymer Heated.

FIG. 9 shows images of fibreglass samples treated with cetyl dimethicone copolyol (CDC) at one month. (A) shows the no treatment negative control samples, (B) shows the samples treated with ceramic coating only, (C) shows the samples treated with ceramic coating and CDC, and (D) shows the samples treated with CDC only.

FIG. 10 shows images of the fibreglass samples shown in FIG. 9 treated with cetyl dimethicone copolyol (CDC) at three months. (A) shows the no treatment control samples, (B) shows the samples treated with ceramic coating only, (C) shows the samples treated with ceramic coating and CDC, and (D) shows the samples treated with CDC only.

FIG. 11 shows images of stainless steel samples treated with ceramic coating and/or CDC at one month. (A) shows the untreated negative control samples, (B) shows the samples treated with ceramic coating only, (C) shows the samples treated with ceramic coating and CDC, and (D) shows the samples treated with CDC only.

FIG. 12 shows images of the stainless steel samples shown in FIG. 11 at three months. (A) shows the untreated control samples, (B) shows the samples treated with ceramic coating only, (C) shows the samples treated with ceramic coating and CDC, and (D) shows the samples treated with CDC only.

FIG. 13 shows images of the stainless steel samples shown in FIG. 11 at four months. (A) shows the untreated control samples, (B) shows the samples treated with ceramic coating only, (C) shows the samples treated with ceramic coating and CDC, and (D) shows the samples treated with CDC only.

FIG. 14 shows images of fibreglass samples at two months, either with no treatment, i.e. the control samples (A), or with 100% (w/w) MPC MF3 treatment (B).

FIG. 15 shows images of the fibreglass samples at four months, either with no treatment, i.e. the control samples (A), or with 100% (w/w) MPC MF3 treatment (B).

FIG. 16 shows images of the stainless steel samples at two months, either with no treatment, i.e. the control samples (A), or with 100% (w/w) MPC MF3 treatment (B).

FIG. 17 shows images of the stainless steel samples at four months, either with no treatment, i.e. the control samples (A), or with 100% (w/w) MPC MF3 treatment (B).

FIG. 18 shows images of nylon rope samples treated with MPC MF3 at two months (A), three months (B) and four months (C).

FIG. 19 illustrates the method of preparing 2-methacryloyloxyethyl phosphorylcholine (MPC) polymers. This image has been taken from the NOF Corporation website [7].

FIG. 20 illustrates four different MPC polymers that have been functionalised with further groups, including a hydrophobic group, a cationic group, a carboxyl group, or nanoparticles. This image has been taken from the NOF Corporation website [7].

FIG. 21 illustrates the polymerisation and functionalisation of MPC polymers with a hydrophobic group, an anionic group, a cationic group, or a hydrogen-bonding group. This image has been taken from the NOF Corporation website [7].

FIG. 22 shows images of an engine and hydraulic lifter coated with the hybrid polymer system (dimethicone copolyol, phosphorylcholine polymer and ceramic), after the initial application (FIG. 22A), and after one month in the sea (FIG. 22B).

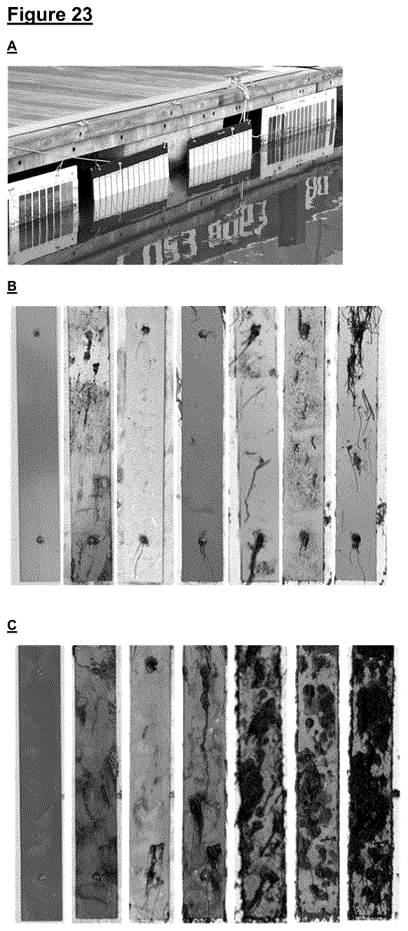

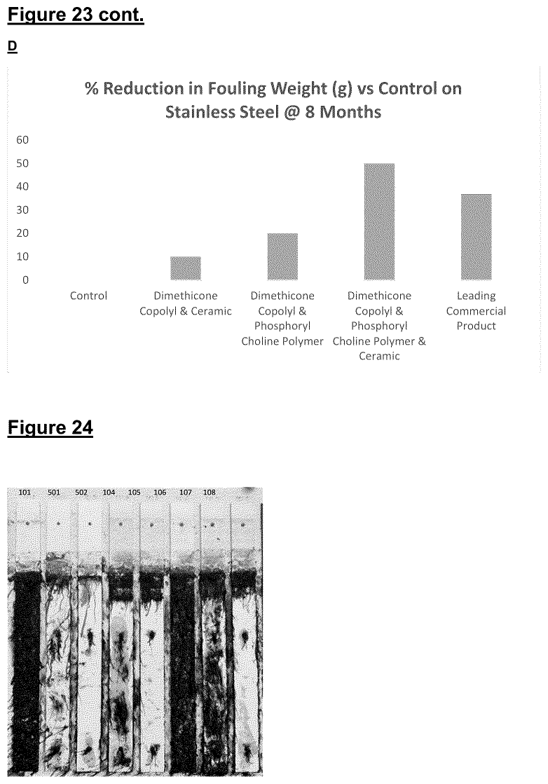

FIG. 23 shows images of static panel stainless steel testing in the water (FIG. 23A), and the stainless steel samples at monthly intervals up to six months when coated with the hybrid polymer coating (FIG. 23B), or a leading commercial product (FIG. 23C). FIG. 23D also illustrates the percentage reduction in fouling weight on stainless samples at eight months when using different coatings.

FIG. 24 shows an image of fibreglass samples with different types of coating after four months in the water.

FIG. 25 shows images of a cleaning test in which three samples of stainless steel were cleaned after 12 months using pressure washing at a 3″ distance.

FIG. 26 shows apparatus used to measure drag reduction in a flow tank using a flat plate mounted to a calibrated dynamometer.

### EXAMPLES

The inventor set out to evaluate polymers comprising phosphorylcholine, particularly 2-methacryloyloxyethyl phosphorylcholine (MPC), and polymers comprising dimethicone copolyol, particularly cetyl dimethicone copolyol (CDC), as anti-fouling and anti-corrosive agents. The inventor immersed a test apparatus in a tidal flow, to test the ability of the polymers in preventing fouling and corrosion of different substrate samples, including steel, fibreglass and nylon rope. The inventor also tested the effectiveness of these polymers when combined with a ceramic coating, as anti-fouling and anti-corrosive agents.

### Materials, Methods and Results

### Experimental Method Test Apparatus #1—MPC Polymers

The inventor set out to evaluate polymers comprising phosphorylcholine, particularly 2-methacryloyloxyethyl phosphorylcholine (MPC Polymers) for the prevention of fouling and corrosion.

The first MPC polymer tested was the polymer comprising 2-methacryloyloxyethyl phosphorylcholine and hydrogen-bonding groups, in particular, hydroxyl or carboxylic acid groups (i.e. Lipidure®-MF3).

The second MPC polymer tested was the polymer comprising 2-methacryloyloxyethyl phosphorylcholine and octadecyl 2-methyl-2-propenoate (Formula VI), which forms nanoparticles (i.e. Lipidure®-NS).

A test apparatus was assembled to enable samples to be tested by immersion in a tidal flow for up to eight months. The test apparatus consisted of a Marine buoy (polyform USA size A1), a 24″ steel bicycle wheel, mooring rope (10 mm octaplat nylon rope white) and four stabilising ropes attached at quarterly intervals to the wheel rim. Samples were attached directly to the steel wheel rim using cable ties. The mooring buoy was divided into test areas, which were individually numbered using black spray paint and masking tape. MPC MF3 and MPC NS were applied to the test areas of the mooring buoy three times using a spray application, and a paintbrush was used to ensure an even coating across the test area.

Fibreglass samples were hand prepared using a fibreglass mini kit with resin designed for boats (Osuilati SK200). The fibreglass sheet was cut into 45 mm×45 mm squares. Resin and activator were mixed together in a separate plastic vessel and applied to the first square of fibreglass mat. A second fibreglass mat square was added on top and more resin applied by dubbing with a brush. This was repeated until five layers of fibreglass mat were sandwiched together with resin. This was then repeated to prepare all the fibreglass test squares. Each square was allowed to dry in a plastic tray at ambient room temperature. The side in contact with the tray gave a smooth uniform finish, replicating a boat outer hull surface. The second side had a rougher finish corresponding to the inside of a boat hull. The test samples were then painted with three layers of primer, three layers of white topcoat and two layers of clear lacquer to replicate the final finish on a boat hull. A 5 mm hole was made in each sample and a brass eyelet added to enable attachment to the test rig with a cable tie.

Lipidure MF3 Lot #670501 and Lipidure NS Lot #600932 were provided by the NOF corporation Japan for evaluation. The fibreglass samples were treated with either 100% (w/w) solution of MPC MF3 Polymer or MPC NS Polymer, or a 10% solution of each, which had been prepared by diluting the samples with deionised water (w/w). The solutions were sprayed onto the fibreglass samples and allowed to dry at ambient temperature. Control samples were left untreated. The samples were transported in plastic boxes to protect them and attached to the test rig at the test location on the tidal river Itchen in Southampton on the 27 Nov. 2020. Images of the test rig, which was placed in the sea on 27 Nov. 2020, are shown in FIG. 1.

### Assessment

All sample materials were assessed on a regular basis by visual inspection during the experimental phase, over a period of eight months. At the end of experimental phase fibreglass samples were weighed.

### Results: MPC MF and MPC NS

### Fibreglass at 8 Months

At the end of the experiment, the test rig was removed from the water on the 27 Jul. 2021, eight months exactly after it was first placed in the water. The results for each of the treatment samples are summarised in Table 1 below, and illustrated in FIG. 2.

TABLE 1
Weight of fibreglass samples treated with
MPC polymers compared with control

| | Fouling | % Reduction in |
|---|---|---|
| | Weight* | Fouling Weight |
| Treatment | (g) | vs Control |
| Control | 12.75 | 0.00 |
| 10% (w/w) Lipidure NS | 11.92 | 6.51 |
| 100% (w/w) Lipidure NS | 8.42 | 33.96 |
| 100% (w/w) Lipidure NS | 7.42 | 41.80 |
| Heated | | |
| 10% (w/w) Lipidure MF | 5.42 | 57.49 |
| 100% (w/w) Lipidure MF | 4.92 | 61.41 |
| 100% (w/w) Lipidure MF | 6.42 | 49.65 |
| Heated | | |

*Fouling Weight = Final Sample Weight (g) − Original Sample Weight (g)
Average original weight without fouling = 7.58 g

For reference, the average weight of each fibreglass sample at the beginning of the experiment is 7.58 g. Therefore, the weight increases on the control samples show the very significant weight gain caused by fouling, and the percentage reduction in fouling weight versus the control demonstrates the ability of the test formulations to reduce fouling. Additionally, FIG. 3 illustrates the appearance of the fibreglass treatment samples at 8 months.

### Conclusion: Fibreglass Test Samples

After eight months, the samples all showed significant increases in weight compared with the ˜7.5 g weight per sample at the start of the study. The untreated control samples showed the greatest weight gain of all the samples in the study. The MPC MF Polymer samples showed the greatest reduction in fouling weight of 49-61% vs the control samples. The MPC NS Polymer samples also reduced fouling, however this was less significant at 7%-41% reduction vs the control samples.

The images in FIG. 3 show that the surface coverage and visual mass of material is less for both the MPC MF Polymer and MPC NS Polymer treated samples vs the control samples at eight months. In addition, this pattern of reduction vs control was observed at earlier time points (e.g. 3 and 4.5 months etc.).

This is a very significant result. Eight months in tidal water with no movement simulates the worst-case scenario, i.e. a boat moored and not used for eight months. It would be expected that with use and movement, there would be even further improved reductions in fouling for the treated samples compared to the control.

### Mild Steel Metal Samples at 2 Months

Steel rectangular test samples with a pre-cut key hole section were sourced (IKEA, Sweden). These were treated with either the 10% or 100% (w/w) polymer solutions of MPC MF3 Polymer and MPC NS Polymer in the same way as the fibreglass samples, spraying each surface with polymer solution and allowing it to dry at ambient room temperature. Control samples were left untreated. The results are illustrated in FIG. 4.

### Conclusion: Mild Steel Metal Samples

As illustrated in FIG. 4, the control sample (A) showed the most significant corrosion and surface deposits of all the test samples. MPC MF3 Polymer treated steel samples showed very significant reductions in both corrosion and surface deposition at 2 months vs the control. The 100% (w/w) solution (B) showed the best performance, however the diluted 10% (w/w) solution (D) also showed very good results.

The mild steel treated with MPC NS Polymer showed limited reduction in corrosion and surface deposition, however a significant difference between a 10% (w/w) solution treatment (C) and 100% (w/w) solution treatment (E) could not be seen at this 2-month time point.

In conclusion, the MPC MF3 Polymer showed excellent reduction(s) in both corrosion and surface deposition making it an ideal agent for marine metal surface such as boat engines and mountings, propellers, rigging, eyelets, mooring cleats and the like.

### Stainless Steel Samples at 5 Months

Marine grade A4 stainless steel washers M10×35 mm were sourced from Force 4 Chandlery in Southampton. Control washers were left untreated, while each of the test washers were treated in sets of three. Treatments were was performed in a separate plastic tray per set, by spraying the formula onto the surface and leaving it to air dry at ambient room temperatures for ˜2 hours. This was repeated three times on each side of each test sample. The results are illustrated in FIG. 5 (2.5 months) and FIG. 6 (5 months).

### Conclusion: Stainless Steel Samples

At 2.5 months, the samples treated with 100% (w/w) MPC MF Polymer showed the least fouling/surface deposition (FIG. 5B). The 25% (w/w) MPC MF Polymer (5C) also showed a good reduction in surface deposition and fouling vs the controls. The 10% (w/w) MPC MF Polymer (5D) showed little difference to the control samples.

At five months, all the stainless-steel samples had marine fouling. The control samples showed the worst fouling (FIG. 6A). Samples treated with 25% (w/w) MPC MF Polymer (6C) showed less fouling while the 10% (w/w) MPC MF Polymer (6D) treated samples showed the least fouling. The 100% (w/w) MPC MF Polymer treated samples (6B) showed slightly more fouling vs the 10% (w/w) MPC MF Polymer but less than the control samples.

In conclusion, the treatment with MPC MF Polymer reduced fouling on all samples compared to the control. Better performances were observed at earlier time points (i.e. 2.5 months) compared with the control samples. By five months, the difference vs control was decreasing, suggesting that the coating was reaching the limit of its duration and/or benefit.

### Mooring Buoy Testing

A mooring buoy was divided into eight areas as follows: Area 1, untreated control; Area 2, 10% (w/w) MPC NS Polymer; Area 3, 100% (w/w) MPC NS Polymer, and Area 4, 100% (w/w) MPC MF Polymer Heated; Area 5, untreated control; Area 6, 10% (w/w) MPC MF Polymer; Area 7, 100% (w/w) MPC MF Polymer; Area 8, 100% (w/w) MPC MF Polymer Heated. The results at 6.5 months are shown in FIG. 7. Additionally, a visual assessment was taken at 6.5 months, and the results are summarized in the Table 2 below.

TABLE 2
Visual appearance of mooring buoy treated
with MPC polymers at 6.5 months

| Sample | Treatment | Soft Fouling | Hard Fouling | Barnacles |
|---|---|---|---|---|
| 1 | Control | Moderate | No | 0 |
| 2 | 10% (w/w) MPC | Moderate | Yes | 2 |
| | NS | | | |
| 3 | 100% (w/w) MPC | Moderate | Yes | 1 |
| | NS | | | |
| 4 | 100% (w/w) MPC | Low | No | 0 |
| | NS | | | |
| 5 | Control | Moderate | Yes | 2/3 |
| 6 | 10% (w/w) MPC | Very Little | No | 0 |
| | MF | | | |
| 7 | 100% (w/w) MPC | Very Little | No | 0 |
| | MF | | | |
| 8 | 100% (w/w) MPC | Light | No | 0 |
| | MF | | | |

The mooring buoy was observed again at 8 months, and the results are shown in FIG. 8.

### Conclusion: Mooring Buoy

At 6.5 months, there was early-stage hard fouling and established soft fouling on the buoy. The MPC MF treated areas showed the best prevention of both soft and hard fouling. The MPC NS provided lower performance giving some reduction in fouling, but overall the areas were visually far closer to those observed on the control areas.

At eight months, control area 1 showed fouling at and below the waterline. Areas 2, 3 and 4 (10%, 100% and 100% (w/w) MPC NS) showed less/reduced fouling at and below the waterline compared to the control 1. Area 5, also a control showed less fouling than area 1.

The greatest difference was observed at 6.5 months, with MPC MF providing the best reduction in hard and soft fouling. At 8 months the differences were less significant, indicating a time limit for the coating in terms of its durability/benefit i.e. the point in time where performance drops off.

### Experimental Method Test Apparatus #2—MPC Polymers, a New CDC Polymer, and a Ceramic Coating

The inventor next set out to evaluate cetyl dimethicone copolyol (CDC polymer) for the prevention of fouling and corrosion. Further evaluation of MPC was also made. Additionally the use of a ceramic coating with both polymers was undertaken, to determine if this hybrid system improves efficacy and duration of fouling and corrosion prevention. Exemplary ceramic formulations are illustrated in Table 3 below.

TABLE 3
Ceramic Formulation Examples

| Ingredient | Range | Formula 1 | Formula 2 | Formula 3 |
|---|---|---|---|---|
| Naptha (petroleum) | 60-100% | 60% | 60% | 45% |
| Hydrotreated Heavy | | | | |
| Distillates (petroleum) | 30-60% | 30% | 30% | 45% |
| hydrotreated light | | | | |
| Decamethylcyclo- | 5-10% | 5% | 10% | 8% |
| pentasiloxane | | | | |
| Titanium dioxide | 0-60% | 5% | 0% | 0% |
| (TiO₂) | | | | |
| Zinc Oxide (ZnO). | 0-5% | 0% | 0% | 2% |

Additionally, exemplary formulations of the ceramic coating with MPC and CDC polymers are illustrated in Table 4 below.

TABLE 4
Ceramic Formulation Examples with MPC and CDC Polymers

| Ingredient | Range | Formula 4 | Formula 5 | Formula 6 |
|---|---|---|---|---|
| Naptha (petroleum) | 37-80% | 37% | 37% | 37% |
| Hydrotreated Heavy | | | | |
| Distillates (petroleum) | 18-80% | 19% | 19% | 19% |
| hydrotreated light | | | | |
| Decamethylcyclo- | 3-10%. | 6% | 6% | 6% |
| pentasiloxane | | | | |
| 2-methacryloyloxyethyl | 0-100% | 0% | 38% | 19% |
| phosphorylcholine | | | | |
| (MPC) | | | | |
| cetyl dimethicone | 0-100% | 38% | 0% | 19% |
| copolyol (CDC), | | | | |

The test apparatus #2 was assembled to enable samples to be tested by immersion in a tidal flow for up to 8 months. The test apparatus consisted of a Marine buoy (Anchor Brand A1), a 24″ steel bicycle wheel, mooring rope (10 mm octaplat nylon rope white) and four stabilising ropes attached at quarterly intervals to the wheel rim. Samples were attached directly to the steel wheel rim using cable ties. The mooring buoy was divided into test areas which were individually numbered using black spray paint and masking tape. The CDC and ceramic coating was applied to areas of the mooring buoy with a paintbrush.

Fibreglass samples were hand prepared using a fibreglass mini kit with resin designed for boats (Osuilati SK200). The fibreglass sheet was cut into 45 mm×45 mm squares. Resin and activator were mixed together in a separate plastic vessel and applied to the first square of fibre glass mat, a second fibreglass mat square was added on top and more resin applied by dubbing with a brush. This was repeated until five layers of fibreglass mat were sandwiched together with resin. The test samples were then painted with three layers of primer, three layers of white topcoat and two layers of clear lacquer to replicate the final finish on a boat hull. Stainless Steel Samples (Marine grade A4 stainless steel washers M10×35 mm) were sourced from Force 4 Chandlery in Southampton.

### Sample Preparation

Control Samples were Left Untreated.

Three stainless steel and three fibreglass samples were treated by dip coating in CDC (batch no 99093944) and allowed to dry. This process was repeated three times for each sample.

Three stainless steel and three fibreglass samples were treated with a combination of CDC and ceramic coating. One drop of cetyl dimethicone and three drops of ceramic coating were placed on the sample surface and mixed in situ to form a uniform surface coating that was allowed to dry. This was performed three times on each test surface.

Three stainless steel and three fibreglass samples were treated with the ceramic coating only. Three drops of ceramic coating were placed on the sample surface and spread to form a uniform surface coating that was allowed to dry at ambient temperature. This was performed three time on each test surface.

Finally, a ˜15 cm section of nylon rope was dip coated with 100% (w/w) MPC MF Polymer, and allowed to dry. The process was repeated three times in total. The remaining rope was left untreated.

### Assessment

All sample materials were assessed on a regular basis by visual inspection during the experimental phase.

### Results: Cetyl Dimethicone Copolyol

### Fibreglass Samples

The results of the fibreglass samples treated with CDC only, ceramic coating only, or CDC and ceramic coating, are shown in FIG. 9 (one month) and FIG. 10 (three months).

### Conclusion: CDC Fibreglass Treated Samples

The untreated control samples showed significant surface coverage and fouling by both algae and seaweed (FIGS. 9A and 10A). The ceramic coated samples showed a small improvement compared with the control samples, however the coverage by algae was extensive with some secondary colonisation on sample 66 (FIGS. 9B and 10B). The CDC samples both with and without ceramic coating showed significantly less algal coverage, adherence or growth compared to the control (FIGS. 9C/9D and 10C/10D). Overall, the ceramic coating with CDC and CDC alone, outperformed the control and ceramic coating only.

### Stainless Steel Samples

The results of the stainless steel samples treated with CDC, CDC and ceramic coating, or ceramic coating only, are shown in FIG. 11 (one month), FIG. 12 (three months) and FIG. 13 (four months).

### Conclusions: CDC Stainless Steel Treated Samples

The untreated control samples showed significant fouling by both algae and seaweed (FIGS. 11A/12A/13A). The ceramic coated samples showed very little benefit, with marginally less coverage of the sample surface compared to the controls (FIGS. 11B/12B/13B).

By contrast, the ceramic coating with CDC showed very little surface coverage and significantly out performed the control samples (FIGS. 11C/12C/13C). The CDC dip coated samples (FIGS. 11D/12D/13D) were more effective in limiting surface adhesion than the control and the ceramic only coating, however, slightly greater coverage was observed compared to the CDC with ceramic coating.

### MPC MF3 Treated Fibreglass Samples

Results for the fibreglass samples treated with 100% (w/w) MPC MF3 are shown in FIG. 14 (two months) and FIG. 15 (four months).

### Conclusions: MPC Fibreglass Samples

MPC is an effective anti-fouling treatment for fibreglass samples. The control samples showed heavy fouling at four months with very visible soft fouling, algae and seaweed growth and some limited hard fouling (FIG. 15A). The MPC MF3 treated fibreglass samples showed algae surface coverage predominately, however this was poorly adhered and no significant hard fouling was visible (FIGS. 14B/15B).

MPC MF3 Stainless Steel Samples Results for the stainless steel samples treated with MPC MF3 are shown in FIG. 16 (two months) and FIG. 17 (four months).

### Conclusions: MPC MF3 Stainless Steel

MPC is an effective anti-fouling treatment for stainless steel. The control samples showed heavy fouling at 4 months with very visible soft fouling, algae and seaweed growth and some limited hard fouling starting (FIG. 17A). The MPC MF3 treated stainless steel samples showed algae surface coverage predominately, however this was poorly adhered and no significant hard fouling was visible (FIGS. 16B/17B).

### MPC ME3 Treated Nylon Rope Testing

Results for the nylon rope samples treated with MPC MF3 are shown in FIG. 18.

### Conclusions: MPC MF3 Rope Testing

The rope section treated with MPC MF3 had significantly less fouling than the untreated control section at 4 months (FIG. 18C). The untreated section showed very visible fouling at and beyond 3 months with algae and seaweed growing across the rope surface. In conclusion, the treatment of nylon rope with MPC MF3 has demonstrated very significant fouling prevention to the current 4-month time point.

### Experimental Method Test Apparatus #3—A Hybrid Polymer System

The inventor next set out to test a hybrid polymer system, which is a coating consisting of phosphoryl choline polymer combined with a dimethicone copolyol polymer and a ceramic coating, which had been modified to form an emulsion by the addition of 50% by volume of water. This formulation is white in appearance and can be applied uniformly and stays in a single layer. It can be applied as a thin coat and ‘built up’ by repeated application.

### Testing on Boat Hulls

Four boats were coated with two Zodiac ribs and two Iron Boats. In each case the hull was new and was cleaned with isopropanol and microfibre clothes, to remove any moulding wax and dust from the GRP surface.

Application was made to the underside of the hull, transom, engine mounting brackets and outboard below the splash plate up to the hull moulding line. In the first case, the hybrid polymer system was applied using an applicator pad, which proved to be time consuming and difficult. The three additional boats were coated using a 3″ brush moving vertically and then horizontally. Areas of thicker application were smoothed and spread out with the brush and three coats of the formulation were applied.

Observations: the formula was much faster to apply with a brush than with the applicator pad used on the original Zodiac 5.5 m boat. Each coat took two people approx. 45 minutes to apply, 6 hours total, and there was no additional drying time required between coats.

### Independent Hulls and Outboard Testing

The hybrid polymer coating significantly reduced fouling and was found be easier and faster to clean.

### Testing on Engines and Hydraulic Lifters

Traditional biocide antifoul products containing metal ions are not suitable for engines or lifters since they can form a galvanic cell with the metal components. This can result in galvanic corrosion of the engine components. Galvanic corrosion is an electrochemical process in which one metal corrodes preferentially when it is in electrical contact with another, in the presence of an electrolyte e.g. sea water.

The hybrid polymer system is formulated without metal ions. This allows it to be used on engines and lifters since it will not form a galvanic cell. In use testing on engines and lifters has shown the hybrid polymer is highly effective at preventing fouling and corrosion, as illustrated in FIG. 22.

### Static Panel Testing

Stainless steel samples were treated with the hybrid polymer and were left to remain static at 100-450 mm below the waterline, as shown in FIG. 23A. The samples were removed every month for six months, and images of the samples coated with the hybrid polymer coating (FIG. 23B) and samples coated with a leading commercial product (FIG. 23C) are shown. As can be seen from FIGS. 23B and 23C, the stainless steel samples treated with the hybrid polymer coating showed the best performance and was outstanding, with only light soft algae present. As such, the hybrid polymer system outperformed the commercially available products, being considerably better after six months. Additionally, as shown in FIG. 23D, the hybrid polymer system (dimethicone copolyol, phosphorylcholine polymer and ceramic), resulted in a significant reduction in fouling weight on stainless at eight months, and performed better than the leading commercial product.

### Gel Reinforced Plastic (GRP/Fibre Glass)

The inventor also tested the hybrid polymer system on GRP/fibre glass, and compared this coating with several other types of coating as shown in Table 5.

TABLE 5
Coatings applied to fibreglass samples

| Substrate | # | Coating |
|---|---|---|
| Fibreglass | 101 | Control sample |
| Fibreglass | 501 | Dimethicone copolyol + Ceramic TiO₂ |
| Fibreglass | 502 | Dimethicone copolyol + Ceramic |
| | | emulsion |
| Fibreglass | 104 | Dimethicone copolyol |
| Fibreglass | 105 | Dimethicone copolyol + Ceramic |
| Fibreglass | 106 | Ceramic |
| Fibreglass | 107 | Dimethicone copolyol & phosphoryl |
| | | choline polymer |
| Fibreglass | 108 | dimethicone copolyol & phosphoryl |
| | | choline polymer + Ceramic |

As illustrated in FIG. 24, the control sample (101) had significant soft fouling. The ceramic only sample (106) also showed very significant soft fouling. The silicone copolyol/polymer system (107) without ceramic showed moderate soft fouling coverage.

The combination of polymers with ceramic provides the best foul prevention performance. The dimethicone copolyol with ceramic (105) and the dimethicone copolyol, phosphoryl choline polymer and ceramic (108) systems both performed well, with only light growth below the waterline.

### Experimental Method Test Apparatus #4—A Hybrid Polymer System

Stainless steel samples were tested for their ease and effectiveness to be cleaned with a pressure washer at 3″ distance after 12 months of exposure to sea water.

A negative control steel strip was not coated, and was very difficult to jet wash clean, as shown in the centre image of FIG. 25. Stainless steel coated with a leading commercial product (right hand image of FIG. 25) cleaned to a small degree, but poorly. However, as shown in the left hand image of FIG. 25, stainless steel coated with the composition of the image cleaned very well and quickly. Accordingly, it is clear that coated samples cleaned far easter and better than the control and commercial product, thereby evidencing another key advantage.

Experimental Method Test Apparatus #5—Assessment of Drag Reduction by the Hybrid Polymer Coating Drag reduction was measured in a flow tank using a flow rate of 0.07 m/s to 0.75 m/s. A flat plate was mounted to a calibrated dynamometer, as shown in FIG. 26, and the force (drag) was recorded for the uncoated plate under laminar flow at a range of flow rates. The plate as then coated with the hybrid polymer system, consisting of phosphoryl choline polymer combined with a dimethicone copolyol polymer and ceramic. The force (drag) was measured for the plate coated with the hybrid polymer system at a range of flow rates. The tests showed that the coated plate had a 25%-50% lower drag vs the untreated plate as a control over replicate runs. Such a huge reduction in drag was totally unexpected.

### CONCLUSION

The inventor has demonstrated that polymers comprising phosphorylcholine, particularly 2-methacryloyloxyethyl phosphorylcholine (MPC), and polymers comprising dimethicone copolyol, particularly cetyl dimethicone copolyol (CDC), can effectively prevent hard and soft marine fouling and corrosion on materials including fibreglass, steel, and polymer substrates such as nylon rope. The MPC MF3 polymer performed best as an anti-fouling and anti-corrosive agent on fibreglass and mild and stainless steel, and it was also highly effective on nylon rope and the surface of mooring buoys. The CDC polymer was also found to be very effective on fibreglass and stainless steel samples in preventing fouling.

In addition, the inventor has demonstrated that when combining these polymers with a ceramic coating, the durability of the polymer coating is extended, providing additional secondary product benefits including abrasion resistance, surface smoothness, gloss and durability. The evaluation of this coating on boat hulls and static GRP panels has shown it is highly effective at preventing marine fouling. In addition, testing on engines, lifters and stainless steel static panels has shown it is highly effective at preventing marine fouling and corrosion.

Advantageously, these polymers are highly effective at low levels of application, are environmentally safe with low toxicity and contain no metal or organic biocides. Accordingly, they provide a significant step forward in terms of environmental safety versus existing marketed products, and in addition, they will be less hazardous to humans during the application process.

### REFERENCES

1. classicsailor.com/wp-content/uploads/2015/11/Antifoul.pdf
2. www.pbo.co.uk/gear/pbo-great-uk-antifouling-showdown-26053/3
3. www.nipponpaint-marine.com/en/products/aquaterras/index.html
4. www.seacoat.com
5. Motor Boat & Yachting, April 2022, ‘The Big Antifouling Test’ p76-81
6. https://nofeurope.com/life-science-products/biocompatible-coating-materials/reactive-phosphorylcholine-monomer/
7. https://www.nof.co.jp/business/life/lipidure/english/index.html
8. https://surfachem.com/products/abil-em-go/
9. https://blog.iglcoatings.com/the-science-of-ceramic-coatings/
10. Polymeric and ceramic silicon-based coatings, Journal of Materials Chemistry A, 21-Nov-2018 Barroso et al.
11. Recent developments and applications of protective silicone coatings: A review of PDMS functional materials, Progress in Organic Coatings, Volume 111, October 2017, Pages 124-163

1. Use of a (i) polymer comprising phosphorylcholine and/or (ii) dimethicone copolyol, as an anti-fouling and/or anti-corrosive agent.

2. A method of protecting a surface from fouling and/or corrosion, comprising contacting the surface with a (i) polymer comprising phosphorylcholine and/or (ii) dimethicone copolyol.

3. The use according to claim 1, or the method according to claim 2, wherein the polymer comprises 2-methacryloyloxyethyl phosphorylcholine (MPC), preferably wherein 2-methacryloyloxyethyl phosphorylcholine (MPC) has the formula (I):

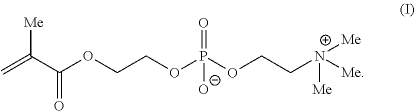 [SMILES: C=C(C)C(=O)OCCOP(=O)([O-])OCC[N+](C)(C)C]

4. The use or the method according to any preceding claim, wherein the polymer comprising phosphorylcholine, preferably 2-methacryloyloxyethyl phosphorylcholine, has a zwitterionic structure.

5. The use or the method according to any preceding claim, wherein the polymer comprising phosphorylcholine, preferably 2-methacryloyloxyethyl phosphorylcholine, is further functionalised by the addition of a co-monomer.

6. The use or the method according to claim 5, wherein the polymer comprising 2-methacryloyloxyethyl phosphorylcholine has the formula (II): 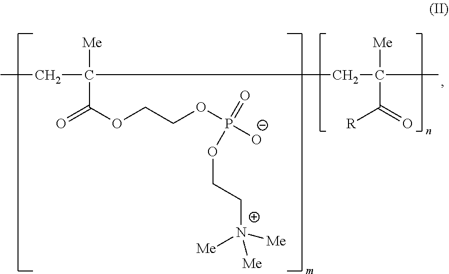
wherein m is an integer of 1 to 1000, and
n is an integer of 1 to 1000, and
R is selected from a group consisting of: a hydrophobic group; an anionic group; a cationic group; and a hydrogen-bonding group.

7. The use or the method according to claim 6, wherein m is an integer of 1 to 500, 1 to 100, 1 to 50, or 1 to 10, and n is an integer of 1 to 500, 1 to 100, 1 to 50, or 1 to 10.

8. The use or the method according to either claim 6 or claim 7, wherein the cationic group is ammonium, sodium, potassium, magnesium, iron, calcium or aluminium.

9. The use or the method according to any one of claims 6-8, wherein the cationic group is trimethylammonium chloride, optionally wherein the polymer has the formula (III):

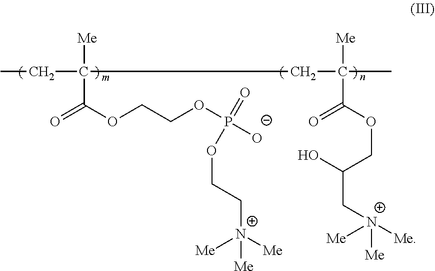

10. The use or the method according to either claim 6 or claim 7, wherein the anionic group is carboxylic acid, methyl esters, chloride, bromide, iodide, sulfate, nitrate, hydroxide, or hydride.

11. The use or the method according to claim 10, wherein the anionic group is sodium salt of carboxylic acid, optionally wherein the polymer has the formula (IV):

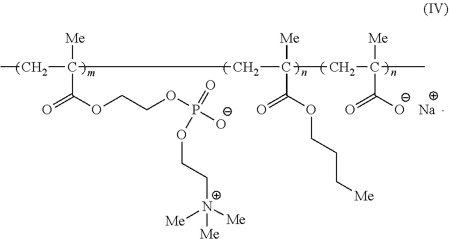

12. The use or the method according to either claim 6 or claim 7, wherein the hydrogen-bonding group is ammonia, chloroform, hydrofluoric acid, or polymers containing, hydroxyl, carboxylic, carbonyl or amide groups, preferably wherein the hydrogen-bonding group is hydroxyl or carboxylic acid.

13. The use or the method according to either claim 6 or claim 7, wherein the hydrophobic group is an alkane, preferably wherein the alkane is methane, ethane, propane, n-butyl, or octadecyl.

14. The use or the method according to claim 13, wherein the hydrophobic group is n-butyl methacrylate, optionally wherein the polymer has the formula (V):

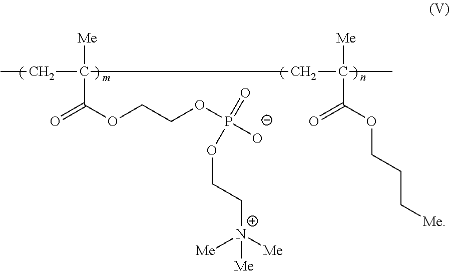

15. The use or the method according to either claim 6 or claim 7, wherein the polymer comprising 2-methacryloyloxyethyl phosphorylcholine forms nanoparticles.

16. The use or the method according to claim 15, wherein the polymer forming nanoparticles comprises octadecyl 2-methyl-2-propenoate, optionally wherein the polymer has the formula (VI):

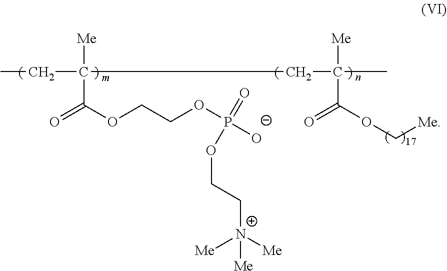

17. The use or the method according to any preceding claim, wherein the polymer is in a composition comprising deionised water, or wherein the polymer is in a composition comprising alcohol.

18. The use or the method according to any preceding claim, wherein the dimethicone copolyol is selected from an alkyl- and alkoxy-dimethicone copolyol having the formula (VII): 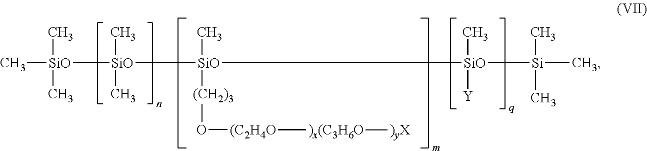
wherein X is selected from the group consisting of hydrogen, alkyl, alkoxy and acyl groups having from about 1 to about 16 carbon atoms, Y is selected from the group consisting of alkyl and alkoxy groups having from about 8 to about 22 carbon atoms, n is from about 0 to about 200, m is from about 1 to about 40, q is from about 1 to about 100, the molecular weight of the residue (C₂H₄O—)ₓ—(C₃H₆O—)_{y}X is from about 50 to about 2000, and x and y are such that the weight ratio of oxyethylene:oxypropylene is from about 100:1 to about 0:100.

19. The use or the method according to any preceding claim, wherein the dimethicone copolyol is selected from C₁₂ to C₂₀ alkyl dimethicone copolyols and mixtures thereof.

20. The use or the method according to any preceding claim, wherein the dimethicone copolyol is cetyl dimethicone coplyol.

21. The use or the method according to any preceding claim, wherein the dimethicone copolyol is in a composition comprising deionised water, or wherein the dimethicone copolyol is in a composition comprising alcohol.

22. A composition comprising a ceramic coating, and a (i) polymer comprising phosphorylcholine and/or (ii) dimethicone copolyol.

23. The composition according to claim 22, wherein the ceramic coating comprises a resin, preferably wherein the resin is a silicone-based polymer.

24. The composition according to either claim 22 or 23, wherein the ceramic coating comprises at least one solvent, preferably wherein the solvent is Naptha (petroleum) Hydrotreated Heavy 60-100%, Distillates (petroleum) hydrotreated light 30-60%, or Decamethylcyclopentasiloxane 5-10%.

25. The composition according to any one of claims 22-24, wherein the ceramic coating comprises at least one additive, preferably wherein the additive is a silane additive.

26. The composition according to any one of claims 22-25, wherein the ceramic coating comprises a crosslinking agent, optionally wherein the crosslinking agent is dimethyl, (Aminoethylaminopropyl)methyl siloxane, trimethylsiloxy terminated at approximately 5-10%.

27. The composition according to any one of claims 22-26, wherein the ceramic coating further comprises titanium dioxide (TiO2) and/or Zinc Oxide (ZnO).

28. The composition according to any one of claims 22-27, comprising a ceramic coating, water, a polymer comprising phosphorylcholine and dimethicone copolyol.

29. The composition according to any one of claims 22-28, wherein the (i) polymer comprising phosphorylcholine and/or (ii) dimethicone copolyol are as defined as in any one of claims 1-21.

30. Use of the composition according to any one of claims 22-29, as an anti-fouling and/or anti-corrosive agent.

31. A method of protecting a surface from fouling and/or corrosion, comprising contacting the surface with the composition according to any one of claims 22-29.

32. The method according to claim 31, further comprising first coating the surface with a primer, preferably wherein the primer comprises cetyl dimethicone copolyol and a ceramic coating.

33. The use or the method according to any one of claims 1-21 and 30-32, wherein the use or the method prevents the adhesion of fouling organisms, such as proteins, cells, microorganisms, algae, plants, and/or animals.

34. Use of:
(i) a polymer comprising phosphorylcholine and/or dimethicone copolyol, or
(ii) a composition comprising a ceramic coating, and a (a) polymer comprising phosphorylcholine and/or (b) dimethicone copolyol,
as a drag-reducing agent.

35. A method of reducing drag on a surface, comprising contacting the surface with:
(i) a polymer comprising phosphorylcholine and/or dimethicone copolyol, or
(ii) a composition comprising a ceramic coating, and a (a) polymer comprising phosphorylcholine and/or (b) dimethicone copolyol.

36. The use or the method according to any one of claims 1-21 and 30-35, wherein the polymer comprising phosphorylcholine, the dimethicone copolyol, or the composition of any one of claims 22-29, is applied to the surface of a material selected from the group consisting of: fibreglass; carbon fibre; graphene; glass; ceramic; acrylic; stone; polyethylene; wood; plastic including nylon, PET, PMMA, PU, PC, PE and PP; synthetic rubbers; metals including steel, stainless steel, aluminium, titanium copper, gold and silver; and alloys of metal including brass and bronze.

37. The use or the method according to any one of claims 1-21 and 30-35, wherein the polymer comprising phosphorylcholine and/or the dimethicone copolyol, or the composition of any one of claims 22-29, is applied to the surface of marine equipment, preferably wherein the marine equipment is selected from the group consisting of: vessels; ships; boats; tankers; barges; submersibles; hulls; engines; hydraulic lifters, a transom, engine mounting brackets, an outboard motor, propellers, mountings; propellers; masts; rigging; eyelets; mooring cleats; cables; anchors; ropes; fishing nets; buoys; chains; rudders; structures; mooring; diving equipment; below-sea windows; underwater lighting; wave power generation systems; wind turbines; and solar panels.

38. The use or the method according to any one of claims 1-21 and 30-35, wherein the polymer comprising phosphorylcholine and/or the dimethicone copolyol, or the composition of any one of claims 22-29, is applied to the surface of bathroom fittings, including showers, baths, sinks, glass fittings, tiles, and/or taps, to automotive, commercial or domestic glass and/or windows, or to garden patios or garden furniture.
